(19) United States
(12) Patent Application Publication
(10) Pub. No.: US 2022/0198411 A1
(43) Pub. Date: Jun. 23, 2022

(54) REAL-TIME PROVISIONING OF TARGETED DIGITAL CONTENT BASED ON DECOMPOSED MESSAGING DATA

(71) Applicant: The Toronto-Dominion Bank, Toronto (CA)

(72) Inventors: Christopher Mark JONES, Villanova, PA (US); Barry Wayne BAIRD, JR., Kennett Square, PA (US); Claude Bernell LAWRENCE, JR., Philadelphia, PA (US); Jonathan Joseph PRENDERGAST, West Chester, PA (US)

(21) Appl. No.: 17/546,376

(22) Filed: Dec. 9, 2021

Related U.S. Application Data
(60) Provisional application No. 63/126,885, filed on Dec. 17, 2020.

(51) Int. Cl. G06Q 20/08; G06N 20/00

(52) U.S. Cl. CPC G06Q 20/085; G06N 20/00

(57) ABSTRACT

The disclosed embodiments include computer-implemented apparatuses and processes that provision, in real-time, targeted digital content based on decomposed, structured messaging data. For example, an apparatus may receive a message associated with an exchange of data involving a first counterparty and a second counterparty. The message includes elements of message data disposed within corresponding message fields, and the message data characterizes a real-time payment requested from the second counterparty by the first counterparty. The apparatus may generate intent data associated with the data exchange based on the elements of the message data, and based on the intent data, obtain digital content associated with the data exchange. The apparatus may transmit notification data that includes the digital content to a device operable by the second counterparty, and an application program executed at the device to may present a portion of the digital content within a digital interface.

### CROSS-REFERENCE TO RELATED APPLICATION

This application claims the benefit of priority under 35 U.S.C. § 119(e) to prior U.S. Provisional Application No. 63/126,885, filed Dec. 17, 2020, the disclosure of which is incorporated by reference herein to its entirety.

### TECHNICAL FIELD

The disclosed embodiments generally relate to computer-implemented systems and processes that provision, in real-time, targeted digital content based on decomposed, structured messaging data.

### BACKGROUND

The mass adoption of smart phones and digital payments within the global marketplace drives an increasingly rapid adoption of real-time payment (RTP) technologies by financial institutions, consumers, vendors and merchants, and other participants in the payment ecosystem. Many RTP technologies emphasize data, messaging, and global interoperability and in contrast to many payment rails, such as those that support credit card payments, embrace the near ubiquity of mobile technologies in daily life.

### SUMMARY

In some examples, an apparatus includes a communications interface, a memory storing instructions, and at least one processor coupled to the communications interface and to the memory. The at least one processor is configured to execute the instructions to receive, via the communications interface, a message associated with an exchange of data involving a first counterparty and a second counterparty. The message includes elements of message data disposed within corresponding message fields, and the message data characterizes a real-time payment requested from the second counterparty by the first counterparty. The at least one processor is configured to execute the instructions to generate intent data associated with the data exchange based on the elements of the message data, and based on the intent data, obtain digital content associated with the data exchange. The at least one processor is configured to execute the instructions to transmit, via the communications interface, notification data that includes the digital content to a device operable by the second counterparty. The notification data causes an application program executed at the device to present a portion of the digital content within a digital interface.

In other examples, a computer-implemented method includes receiving, using at least one processor, a message associated with an exchange of data involving a first counterparty and a second counterparty. The message includes elements of message data disposed within corresponding message fields, and the message data characterizes a real-time payment requested from the second counterparty by the first counterparty. The computer-implemented method includes, using the at least one processor, generating intent data associated with the data exchange based on the elements of the message data and, based on the intent data, obtaining digital content associated with the data exchange. The computer-implemented method includes transmitting, using the at least one processor, notification data that includes the digital content to a device operable by the second counterparty. The notification data causes an application program executed at the device to present a portion of the digital content within a digital interface.

Additionally, in some examples, a tangible, non-transitory computer-readable medium stores instructions that, when executed by at least one processor, cause the at least one processor to perform a method that includes receiving a message associated with an exchange of data involving a first counterparty and a second counterparty. The message includes elements of message data disposed within corresponding message fields, and the message data characterizes a real-time payment requested from the second counterparty by the first counterparty. The method included generating intent data associated with the data exchange based on the elements of the message data, and, based on the intent data, obtaining digital content associated with the data exchange. The method includes transmitting notification data that includes the digital content to a device operable by the second counterparty. The notification data causes an application program executed at the device to present a portion of the digital content within a digital interface.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a block diagram of an exemplary computing environment, in accordance with some exemplary embodiments.

FIG. 2A is a block diagram illustrating a portion of an exemplary computing environment, in accordance with some exemplary embodiments.

FIG. 2B illustrates portions of an exemplary request for payment (RFP) message, in accordance with some exemplary embodiments.

FIGS. 3A-3D and 4 are block diagrams illustrating portions of an exemplary computing environment, in accordance with some exemplary embodiments.

FIGS. 5A, 5B, and 5C are flowcharts of exemplary processes for provisioning targeted digital content associated with an initiated exchange of data in real-time, and contemporaneously with the initiation of the data exchange, in accordance with some embodiments.

Like reference numbers and designations in the various drawings indicate like elements.

### DETAILED DESCRIPTION

Today, the mass adoption of smart phones and digital payments within the global marketplace drives an adoption of real-time payment (RTP) technologies by financial institutions, consumers, vendors and merchants, and other participants in the payment ecosystem. These RTP technologies often emphasize data, messaging, and global interoperability and in contrast to conventional payment rails, may embrace the near ubiquity of mobile technologies in daily life to provide, to the participants in the RTP ecosystem, real-time service and access to funds. To facilitate the strong emphasis on data, messaging, and global interoperability between financial institutions, many RTP technologies adopt, and exchange data formatted in accordance with, one or more standardized data-exchange protocols, such as the ISO 20022 standard for electronic data exchange between financial institutions.

For example, a customer of a financial institution may initiate a transaction to purchases one or more products or services from a merchant or retailer, either through in-person interaction at a physical location of the merchant or retailer, or through digital interactions with a computing system of the merchant (e.g., via a web page or other digital portal). In some instances, and to fund the initiated purchase transaction, the customer may provide the merchant with data characterizing a payment instrument, such as credit card account issued by the financial institution (e.g., via input provisioned to the web page or digital portal, or based on an interrogation of a physical payment card by point-of-sale terminal, etc.). The merchant computing system may perform operations that generate elements of messaging data that identify and characterize the merchant and the initiated purchase transaction, and that include portions of the data characterizing the payment instrument, and that submit the generated elements of messaging data to a transaction processing network or payment rail in accordance with a predetermined schedule, e.g., in batch form with other elements of messaging data at a predetermined time on a daily basis. In some instances, one or more computing systems of the transaction processing network or payment rail may perform operations that execute, clear, and settle the initiated purchase transaction involving the payment instrument within a predetermined temporal interval subsequent to the initiation of the purchase transaction, such as, but not limited to, forty-eight hours.

In other examples, the merchant and the financial institution of the customer may represent participants in the RTP ecosystem, and the merchant computing system (or a computing system associated with a financial institution of the merchant) may generate a message, e.g., a Request for Payment (RFP) message, that requests a real-time payment from the customer that funds the initiated purchase transaction, and may transmit that message to one or more computing systems of the financial institution of the customer, e.g., directly or through one or more intermediate systems associated with the RTP ecosystem, such as a clearinghouse system. The generated and transmitted RFP message may, for example, be formatted in accordance with the ISO 20022 data-exchange format, and may include message fields populated with information that includes, but is not limited to, information identifying the customer and the merchant, information characterizing the requested payment (e.g., a requested payment amount, a requested payment date, an identifier of an account selected by the customer to fund the requested, real-time payment, or an identifier of an account of the merchant capable of receiving the requested, real-time payment, etc.) and information characterizing the initiated purchase transaction (e.g., a transaction date or time, or an identifier of one or more of the products or services involved in the initiated purchase transaction, such as a corresponding UPC, etc.). Further, the ISO-20022-compliant RFP message may also include a link within a structured or unstructured message field to information, such as remittance data, associated with the requested, real-time payment (e.g., a long- or shortened Uniform Resource Location (URL) pointing to a formatted invoice or statement that includes any of the information described herein).

In some examples, the elements of structured or unstructured data maintained within the message fields of exemplary, ISO-20022-compliant RFP messages described herein may extend beyond the often-limited content of the message data transmitted across many existing payment rails and transaction processing networks. Further, when intercepted and processed by a computing system of the financial institution of the customer (e.g., an FI computing system), these elements of structured or unstructured RFP message data may be processed by the FI computing system to determine, among other things, a customer intent associated with the initiated purchase transaction, to identify one or more targeted offers or incentives that are available to the customer and that are associated with, or consistent with, the determined customer intent, and to provision, to a device of the customer in real-time and contemporaneously with the receipt of the RFP message, elements of digital content of that not only prompt the customer to approve or reject the requested, real-time payment associated with the initiated purchase transaction, but that also prompt the customer to accept, or reject, each or a selected subset of the targeted offers of incentives.

By way of example, and using any of the exemplary processes described herein, the FI computing system may provision, to the customer device, elements of a payment notification that identify and characterize the real-time payment for the initiated purchase transaction requested from the customer by the merchant, along with elements of one or more incentive notifications, which identify and characterize corresponding ones of the targeted offers or incentives associated with, and consistent with, the determined customer intent. Upon presentation within corresponding portions of a digital interface of the customer device by an executed application program, the elements of the payment notification may identify and characterize the requested, real-time payment and may prompt the customer to approve (or reject) the requested, real-time payment, while the elements of each of the incentive notifications may identify and characterize corresponding ones of the targeted offers or incentives, and prompt the customer to accept (or decline) the corresponding ones of the targeted offers or incentives in real-time, and currently with, the approval (or rejection) of the requested, real-time payment.

Certain of the exemplary processes described herein, which decompose the structured message fields of an ISO-20022-compliant RFP message to obtained elements of decomposed message data characterizing the customer, the merchant, the initiated purchase transaction, and the requested, real-time payment, which analyze the elements of decompose message data to identify one or more targeted offers and incentives consistent with a determined customer intent of the initiated purchase transaction, and which provision data characterizing the one or more targeted offers and incentives to the customer device for presentation within a digital interface in real-time and contemporaneously with the initiated purchase transaction, may be implemented in addition to, or as an alternate to, many processes that relay on the often-limited content of temporally delayed message data transmitted across many existing payment rails and transaction processing networks.

### A. Exemplary Computing Environments

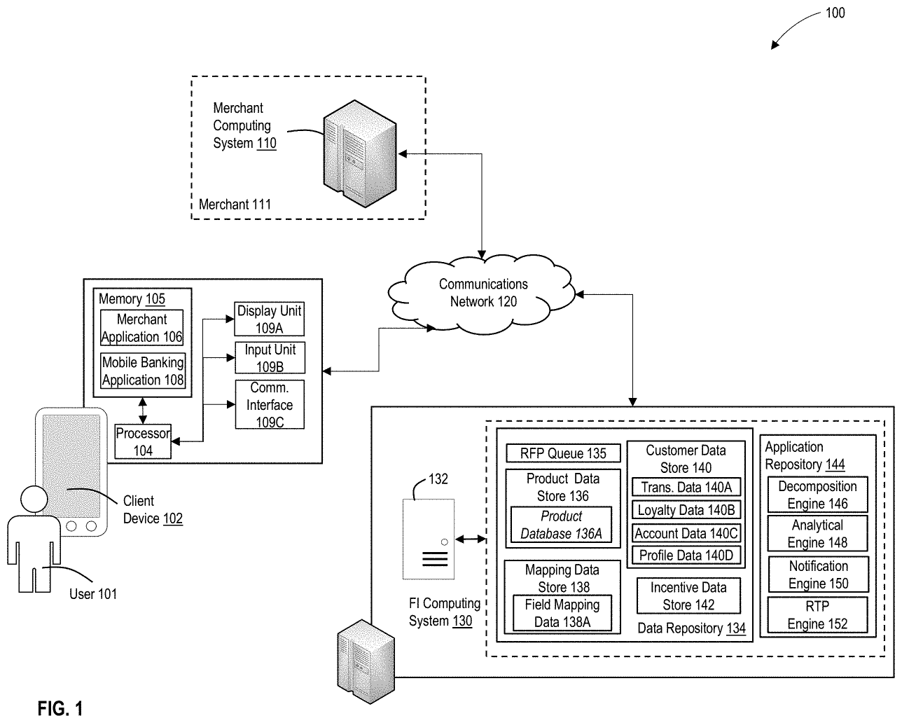

FIG. 1 is a diagram illustrating an exemplary computing environment 100 that includes, among other things, one or more computing devices, such as a client device 102, and one or more computing systems, such as a merchant computing system 110 and a financial institution (FI) system 130, each of which may be operatively connected to, and interconnected across, one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

Client device 102 may include a computing device having one or more tangible, non-transitory memories, such as memory 105, that store data and/or software instructions, and one or more processors, e.g., processor 104, configured to execute the software instructions. The one or more tangible, non-transitory memories may, in some aspects, store software applications, application modules, and other elements of code executable by the one or more processors, such as, but not limited to, an executable web browser (e.g., Google ChromeTM, Apple Safari™, etc.), an executable application associated with merchant computing system 110 (e.g., merchant application 106), and additionally or alternatively, an executable application associated with FI computing system 130 (e.g., mobile banking application 108). In some instances, not illustrated in FIG. 1, memory 105 may also include one or more structured or unstructured data repositories or databases, and client device 102 may maintain one or more elements of device data and location data within the one or more structured or unstructured data repositories or databases. For example, the elements of device data may uniquely identify client device 102 within computing environment 100, and may include, but are not limited to, an Internet Protocol (IP) address assigned to client device 102 or a media access control (MAC) layer assigned to client device 102.

Client device 102 may also include a display unit 109A configured to present interface elements to a corresponding user, such as a user 101, and an input unit 109B configured to receive input from user 101, e.g., in response to the interface elements presented through display unit 109A. By way of example, display unit 109A may include, but is not limited to, an LCD display unit or other appropriate type of display unit, and input unit 109B may include, but is not limited to, a keypad, keyboard, touchscreen, voice activated control technologies, or appropriate type of input unit. Further, in additional aspects (not illustrated in FIG. 1), the functionalities of display unit 109A and input unit 109B may be combined into a single device, e.g., a pressure-sensitive touchscreen display unit that presents interface elements and receives input from user 101. Client device 102 may also include a communications interface 109C, such as a wireless transceiver device, coupled to processor 104 and configured by processor 104 to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Examples of client device 102 may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface device or unit, such as display unit 109A. In some instances, client device 102 may also establish communications with one or more additional computing systems or devices operating within environment 100 across a wired or wireless communications channel, e.g., via the communications interface 109C using any appropriate communications protocol. Further, user 101 may operate client device 102 and may do so to cause client device 102 to perform one or more exemplary processes described herein.

Merchant computing system 110 and FI computing system 130 may each represent a computing system that includes one or more servers and one or more tangible, non-transitory memory devices storing executable code, application engines, or application modules. Each of the one or more servers may include one or more processors, which may be configured to execute portions of the stored code, application engines, or application modules to perform operations consistent with the disclosed exemplary embodiments. For example, as illustrated in FIG. 1, the one or more servers of FI computing system 130 may include server 132 having one or more processors configured to execute portions of the stored code, application engines, or application modules maintained within the one or more corresponding, tangible, non-transitory memories. In some instances, merchant computing system 110 and/or FI computing system 130 may correspond to a discrete computing system, although in other instances, merchant computing system 110 or FI computing system 130 may correspond to a distributed computing system having multiple, computing components distributed across an appropriate computing network, such as communications network 120 of FIG. 1A, or those established and maintained by one or more cloud-based providers, such as Microsoft Azure™, Amazon Web Services™, or another third-party, cloud-services provider. Further, each of merchant computing system 110 and FI computing system 130 may also include one or more communications units, devices, or interfaces, such as one or more wireless transceivers, coupled to the one or more processors for accommodating wired or wireless internet communication across network 120 with other computing systems and devices operating within environment 100 (not illustrated in FIG. 1).

By way of example, merchant computing system 110 may be associated with, or operated by, a merchant 111 that offers products or services for sale to one or more customers, such as, but not limited to, user 101 that operates client device 102. In some instances, merchant computing system 110 may exchange data programmatically with one or more application programs executed at client device 102, such as merchant application 106, and based on the programmatically exchanged data, client device 102 may perform any of the exemplary processes described herein to initiate a transaction to purchase one or more of the products or services offered for sale by merchant 111. Further, and as described herein, FI computing system 130 may be associated with, or operated by, a financial institution that offers financial products or services to one or more customers, such as, but not limited to, user 101. The financial products or services may, for example, include a payment instrument issued to user 101 by the financial institution and available to fund the initiated purchase transaction, and examples of the payment instrument may include, but are not limited to, a credit card account issued by the financial institution or a checking, savings, or other deposit account issued by and maintained at the financial institution.

In some instances, FI computing system 130 may perform any of the exemplary processes described herein to obtain, receive, or intercept a request-for-payment (RFP) message associated with the initiated purchase transaction between a first counterparty (e.g., merchant 111 of FIG. 1) and a second counterparty (e.g., user 101 of FIG. 1). As described herein, the received RFP message may be formatted and structured in accordance with one or more standardized data-exchange protocols, such as the ISO 20022 standard for electronic data exchange between financial institutions. Further, and based on elements of mapping data that characterize a structure, composition, or format of one or more data fields of the ISO-20002-compliant RFP message, FI computing system 130 may perform any of the exemplary processes described herein to decompose the received RFP message and obtain message data characterizing user 101, merchant 111, and additionally, or alternatively, the initiated purchase transaction.

Further, and based on the elements of decomposed message data characterizing user 101, merchant 111, and the initiated purchase transaction, and in some instances, based on additional elements of customer profile, account, or transaction data associated with user 101 (and other customers of the financial institution), FI computing system 130 may also perform any of the exemplary processes described herein to generate elements of intent data that characterize a customer intent associated with the initiated purchase transaction, and based on determined customer intent, that determine and provision elements of digital content characterizing one or more targeted offers or incentives to client device 102 in real-time and contemporaneously with the initiated purchase transaction. As described herein, examples of these targeted offers or incentives may include, but are not limited to, or more merchant-, customer-, and/or loyalty-based offers or incentives associated with user 101 or the initiated purchase transaction, including an offer to provision, to user 101, a financial product capable of financing all or a portion of the initiated purchase transaction (e.g., an unsecured personal loan, an installment loan, etc.).

By way of example, FI computing system 130 may package the one or more elements of digital content characterizing one or more targeted offers or incentives, and additional elements of data characterizing the real-time payment requested from user 101 by merchant 111, into corresponding portions of a notification, which FI computing system 130 may transmit across communications network 120 to client device 102. As described herein, client device 102 may receive the transmitted notification, and one or more application programs executed at client device 102, such as mobile banking application 108, may perform any of the exemplary processes described herein to present interface elements representative of all of a selected portion of the notification within one or more portions of a corresponding digital interface (e.g., via display unit 109A). For example, the presented interface elements may prompt user 101 to provide input to client device 102 (e.g., via input unit 109B) that approves the payment requested by merchant 111 (e.g., as specified by the received RFP message), and/or or that accepts one or more of the targeted offers or incentives consistent with the customer intent, in real-time and contemporaneously within the initiation of the purchase transaction.

Further, FI computing system 130 may perform any of the exemplary processes described herein to further process the elements of decomposed message data characterizing user 101, merchant 111, and the initiated purchase transaction to generate elements of behavioral data that characterize a current, or time-evolving, transactional behavior of user 101. The behavioral data may, for example, characterize a pattern of prior purchase transactions that involve particular counterparties (e.g., retailers or merchants, etc.), that involve particular products or services, or that are associated with particular geographic locations or regions, and FI computing system 130 may perform operations that transmit the generated elements of behavioral data, and additionally or alternatively, one or more elements of the intent data, across network 120 to computing systems associated with a predetermined set of merchants or retailers (e.g., having a relationship with the financial institution, etc.), such as merchant computing system 110 of merchant 111. In some instances, one or more of the computing systems associated with the predetermined set of merchants or retailers, such as merchant computing system 110, may perform any of the exemplary processes described herein to process the elements of behavioral data and/or the intent data and provision, to client device 102, a notification that includes elements of digital content characterizing one or more additional, or alternate targeted offers or incentives associated with user 101, a corresponding one or more merchants or retailers (e.g., merchant 111), and the initiated purchase transaction, e.g., in real-time and contemporaneously with the initiated purchase transaction.

To facilitate a performance of one or more of these exemplary processes, Fl computing system 130 may maintain, within the one or more tangible, non-transitory memories, a data repository 134 that includes, but is not limited to, a request-for-payment (RFP) message queue 135, a product data store 136, a mapping data store 138, a customer data store 140, and an incentive data store 142. As described herein, RFP queue 135 may include one or more discrete RFP messages received by FI computing system 130 using any of the exemplary processes described herein. In some instances, the RFP messages maintained within RFP queue 135 may be prioritized in accordance with a time or date of receipt by FI computing system 130 or with data characterizing the requested payment associated with each of the RFP messages, and each of the prioritized RFP messages may be associated with a corresponding temporal pendency. Further, FI computing system 130 may perform any of the exemplary processes described herein to provision elements of notification data associated with each of the prioritized RFP message to a computing system or device associated with a corresponding customer (e.g., client device 102 associated with user 101), and FI computing system 130 may perform operations that maintain each of the prioritized RFP messages within RFP queue 135 until a receipt, at FI computing system 130, of confirmation data from corresponding ones of the computing systems or devices indicating an approval, or a rejection, of the corresponding requested payment, or until an expiration of the corresponding pendency period.

Product data store 136 may include one or more structured or unstructured data records that establish a database 136A of products available for provisioning to customers, such as, but not limited to one or more financial products or one or more loyalty or rewards programs associated with the financial institution or the one or more merchants or retailers having the relationship with the financial institution. Examples of the financial products include, but are not limited to, unsecured, personal loan, installment loans, or secured or unsecured credit card accounts, and the data records of product database 136A may include, for each of the financial products, a corresponding product identifiers and data characterizing one or more internal qualification or underwriting procedures associated with a provisioning of the corresponding financial product to user 101. Further, the data records of product database 136A may include, for each of the loyalty or rewards products, a corresponding product identifier and data characterizing one or more qualification criteria, and one or more term or conditions, associated with an enrollment of user 101 into the corresponding one of the rewards or loyalty program.

Mapping data store 138 may include structured or unstructured data records that maintain one or more elements of field mapping data 138A. For example, and as described herein, FI computing system 130 may receive, obtain, or intercept one or more RFP messages, each of which may be formatted and structured in accordance with a corresponding, standardized data-exchange protocol, such as the ISO 20022 standard for electronic data exchange between financial institutions. In some instances, the one or more elements of field mapping data 138A may characterize a structure, composition, or format of the message data populating one or more data fields of the ISO-20002-compliant RFP message, or a corresponding RFP message compliant with an additional, or alternate, standardized data-exchange protocol.

In some instances, customer data store 140 may include structured or unstructured data records that maintain information identifying and characterizing one or more customers of the financial institution, and further, interactions between these customers and not only the financial institution, but also other unrelated third parties, such as the merchants or retailers described herein. For example, as illustrated in FIG. 1, customer data store 140 may include one or more elements of transaction data 140A, which identify and characterize prior purchase or payment transactions involving the customers of the financial institution (such as, but not limited to, user 101), one or more elements of loyalty data 140B, which identify and characterize one or more merchant- or retailer-specific loyalty programs in which the customers of the financial institution participate (e.g., one or more loyalty programs in which user 101 participates, such as a loyalty program associated with merchant 111), one or more elements of account data 140C, which may identify and characterize one or more accounts held by the customers, one or more elements of customer profile data 140D, which identify and characterize corresponding ones of the customers and their interactions with the financial institution.

By way of example, for a corresponding one of the customer, such as user 101, the elements of transaction data 140A may include data identifying one or more prior purchase or payment transactions initiated by user 101 (e.g., a unique, alphanumeric transaction identifier assigned by FI computing system 130), and may include values of transaction parameters that characterize each of the prior purchase or payment transactions, such as a transaction data or time, a transaction amount, an identifier of a corresponding counterparty, or an identifier of an account (e.g., an account number, etc.) that funds, or receives proceeds from, the prior purchase or payment transaction. Further, the accounts held by the customers of the financial institution may include, but are not limited to, a deposit account (e.g., a checking or a savings account issued by the financial institution), a credit-card account, or an account associated with an additional, or alternate, financial product, such as an unsecured personal loan or an installment loan, and the elements of account data 140C may include, for an account held by a corresponding one of the customers, such as user 101, all or a portion of an account number (e.g., an actual account number, a tokenized account number, etc.) and data characterizing a status of the account (e.g., a current balance, an overdue balance, length of account existence, etc.) and interactions between user 101 and the account (e.g., amounts and dates of withdrawals, etc.). In some examples, for a corresponding one of the customers, such as user 101, the elements of customer profile data 140D may include, but are not limited to, a customer identifier of user 101 (e.g., an alphanumeric login credential, a customer name, etc.), a postal address of user 101, and demographic data characterizing user 101 (e.g., a customer age, customer profession, etc.).

Incentive data store 142 may include structured or unstructured data records that include elements of digital content associated with corresponding ones of the merchant, customer-, and/or loyalty-based offers or incentives available for provisioning to user 101. By way of example, when presented to user 101 by client device 102 within a digital interface, the elements of digital content identify corresponding ones of the merchant, customer-, and/or loyalty-based offers or incentives and prompt user 101 to provide additional input to client device 102 that accepts, or alternatively, declines, the corresponding ones of the merchant, customer-, and/or loyalty-based offers or incentives. For instance, merchant, customer-, and/or loyalty-based offers or incentives may include, but are not limited to, a discount on an additional purchase of a product or service at merchant 111 or another merchant or retailer having a relationship with the financial institution, an incentive to enroll in a loyalty or rewards program (e.g., one or the loyalty or rewards programs identified characterized by the data records of product database 136A) associated with merchant 111 (e.g., an additional discount on the initiated purchase transaction, a provisioning of a predetermined number of bonus points, etc.), or an offer to fund the initiated purchase transaction using a particular one of the financial products identified and characterized by the data records of product database 136A, such as an unsecured personal loan. Further, in some instances, the structured or unstructured data records of incentive data store 142 may store each of the elements of digital content in conjunction with one or more elements of layout data, which specify a disposition of the elements of digital content, or visual characteristics of the elements of digital content, when rendered for presentation within a corresponding digital interface by one or more application programs executed by client device 102.

Further, and to facilitate the performance of any of the exemplary processes described herein, FI computing system 130 may also maintain, within the one or more tangible, non-transitory memories, an application repository 144 that maintains, but is not limited to, a decomposition engine 146, an analytical engine 148, and a notification engine 150, each of which may be executed by the one or more processors of server 132.

For example, and upon execution by the one or more processors of Fl computing system 130, executed decomposition engine 146 may perform any of the exemplary processes described herein to obtain field mapping data 138A from mapping data store 138, to apply field mapping data 138A to a received, obtained, or intercepted RFP message, and based on the application of field mapping data 130A to the RFP message, to decompose the RFP message and obtain elements of decomposed message data that not only identify and characterize each counterparty involved in an initiated purchase transaction (e.g., user 101 and merchant 111, described herein), but that also characterize the initiated purchase transaction. Further, and upon execution by the one or more processors of FI computing system 130, executed analytical engine 148 may perform any of the exemplary processes described herein to process the elements of decomposed message data obtained from the message fields of the RFP message, to generate elements of intent data that characterize a customer intent associated with the initiated purchase transaction, and based on customer intent, to generate elements of incentive data characterizing one or more targeted offers or incentives to client device 102 in real-time and contemporaneously with the initiated purchase transaction.

Upon execution by the one or more processors of FI computing system 130, notification engine 150 may perform any of the exemplary processes described herein to generate one or more elements of a payment notification that, when provisioned to client device 102 by FI computing system 130, cause one or more application programs executed by client device 102 to present interface elements within a corresponding digital interface that prompt user 101 to provide an approval of the real-time payment requested by merchant 111 via the RFP message, e.g., contemporaneously with the initiation of the purchase transaction. Further, in some examples, executed notification engine 150 may perform any of the exemplary processes described herein to generate one or more incentive notification that include the generated or obtained elements of incentive data and digital content characterizing the targeted offers or incentives associated with the determined customer intent, and to cause FI computing system 130 to provision the incentive notification to client device 102, e.g., separately or concurrently with the payment notification.

Further, and upon execution by the one or more processors of FI computing system 130, RTP engine 152 may perform any of the exemplary processes described herein to initiate a payment, such as a real-time payment, requested by one or more computing systems associated with a corresponding counterparty, such as merchant computing system 110 or merchant 111. For example, and as described herein, executed RTP engine 152 may initiate a real-time payment for a purchase transaction initiated between, and involving, user 101 and merchant 111, and executed RTP engine 152 may generates a corresponding real-time payment message in accordance with one or more standardized data-exchange protocols, such as the ISO 20022 standard.

### B. Computer-Implemented Processes for Provisioning Targeted Digital Content in Based on Decomposed, Structured Messaging Data

In some instances, a customer of the financial institution, such as user 101, may elect to initiate a purchase of a product or service from a particular merchant, such as merchant 111, and may provide input to client device 102 (e.g., via input unit 109B) that triggers an execution of one or more locally maintained application programs associated with merchant 111, such as merchant application 106 or a web browser. By way of example, merchant 111 may correspond to a local travel agency (e.g., “Jonathan's Travel”) disposed proximate to user's 101 home in Washington, D.C., and upon execution by the one or more processors of client device 102, executed merchant application 106 may perform operations that present, via display unit 109A, a digital interface 200 that enables user 101 to select for purchase one or more travel-related products or services offered for sale by merchant 111, such as tickets or air or train travel, reservations for lodging, car-rental services, etc.), and to submit payment for the selected, travel-related products or services to merchant 111.

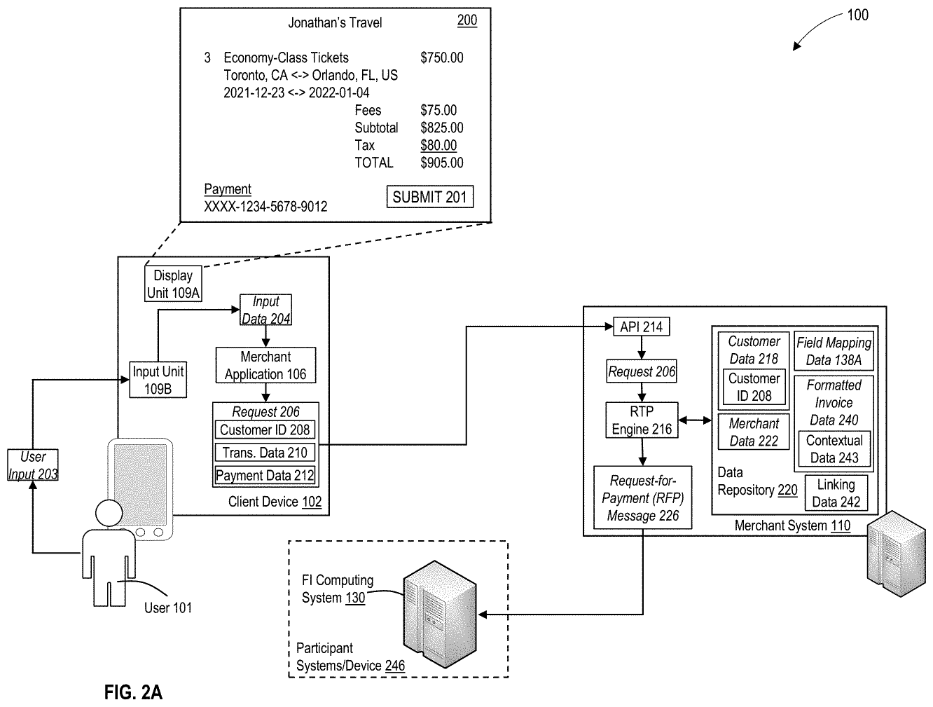

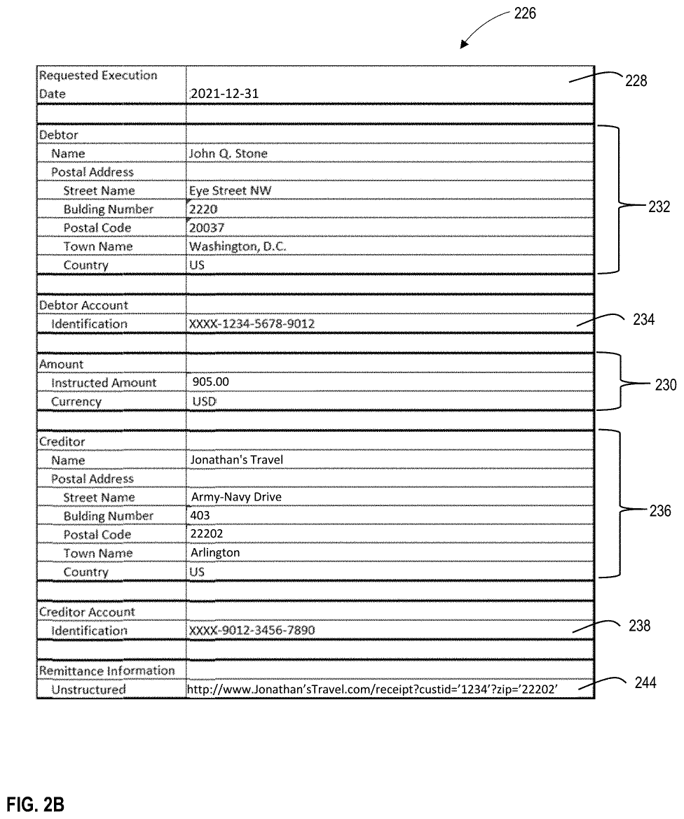

Based on portions of digital interface 200, user 101 may provide input to input unit 109B of client device 102 that specifies a selection of three, economy-class airline tickets to travel from Toronto, Canada, to Orlando, Fla., on Dec. 13, 2021, and to return from Orlando, Florida on Jan. 4, 2022, and that specifies a particular payment instrument available to fund the purchased airline tickets (e.g., a credit card account or deposit issued to user 101 by the financial institution, etc.). For example, as illustrated in FIG. 2A, digital interface 200 may include interface elements that specify the selection, by user 101, of the three, economy-class airline tickets priced at $750.00 and fees of $75.00 associated with the selected airline tickets, and that specify a pre-tax subtotal of $825.00 for the purchased airline tickets, an imposed sales tax of $80.00, and further, a total purchase price of $905.00. Further, the interface elements may also specify payment data that identifies the particular payment instrument available to fund the purchase transaction, such as an account number (e.g., “XXXX-1234-5678-9012”), an expiration date, and/or a card verification code. As illustrated in FIG. 2A, all or a selected portion of the payment data presented within digital interface 200 may be tokenized or otherwise obscured to, among other things, maintain a confidentiality of the presented elements of the payment data.

Further, as illustrated in FIG. 2A, digital interface 200 may also include a selectable interface element, such as “SUBMIT” icon 201, that when selected by user 101, confirms an intention of user 101 to initiate the $905.00 purchase of the airline tickets involving the particular payment instrument, and requests a submission of corresponding elements of transaction and payment information to a computing system associated with merchant 111, e.g., merchant computing system 110. For example, input unit 109B of client device 102 may receive additional input 203 indicative of a selection, by user 101, of SUBMIT icon 201, and may route, to executed merchant application 106, input data 204 that includes, but is not limited to, information specifying the purchased airline tickets and fees, the subtotal, imposed sales tax, and total purchase price, and the particular payment instrument that funds the initiated purchase transaction.

In some instances, executed merchant application 106 package all, or a selected portion, of input data 204 into corresponding portions of a purchase request 206, and may perform operations that cause client device 102 to transmit purchase request 206 across communications network 120 to a computing system associated with merchant 111, such as merchant computing system 110. Further, although not illustrated in FIG. 2A, executed merchant application 106 may also perform operations that encrypt all, or a portion, of purchase request 206 using an appropriate encryption key (e.g., a public cryptographic key of merchant computing system 110, etc.) prior to transmission across communications network 120.

In some instances, purchase request 206 may include a customer identifier 208 associated with user 101 (e.g., an alphanumeric login credential that uniquely identifies user 101 at merchant computing system 110), elements of transaction data 210 that specify values of one or more parameters characterizing the initiated purchase transaction, and elements of payment data 212 that specify the particular payment instrument selected to fund the purchase transaction. For example, the elements of transaction data 210 may include an identifier of each of the purchased products (e.g., a universal product code (UPC) associated with the economy-class airline tickets, etc.), the subtotal for the purchase transaction (e.g., $825.00), the imposed sales tax (e.g., $80.00), the total purchase price (e.g., $905.00), and a time or date of the initiated purchase transaction (e.g., 9:30 a.m. on Dec. 1, 2020). Additionally, in some examples, the elements of payment data 212 may include, among other things, all or a selected portion of the account number (e.g., in tokenized form, etc.), the corresponding expiration data, and/or the corresponding card verification code.

A programmatic interface established and maintained by merchant computing system 110, such as application programming interface (API) 214, may receive purchase request 206 from client device 102, and may route purchase request 206 to a real-time payment (RTP) engine 216 executed by the one or more processors of merchant computing system 110. In some instances, as described herein, all, or a selected portion, of purchase request 206 may be encrypted, and executed RTP engine 216 may perform operations that decrypt the encrypted portions of purchase request 206 using a corresponding, and appropriate, decryption key, such as a private cryptographic key associated with merchant computing system 110. Executed RTP engine 216 may also perform operations that, based on portions of purchase request 206, verify that user 101 represents a registered customer of merchant 111. For example, executed RTP engine 216 may parse purchase request 206 and obtain customer identifier 208, which uniquely identifies user 101, and identify one or more elements of customer data associated with customer identifier 208 within a corresponding merchant data repository 220. The identified elements of customer data 218 may include, among other things, a full name of user 101 and a postal address of user 101, and based on the identification of the elements of customer data 218 and their association with customer identifier 208, executed RTP engine 216 may verify that user 101 represents a registered customer of merchant 111.

Executed RTP engine 216 may also extract, from merchant data repository 220, one or more elements of merchant data 222 and one or more elements of field mapping data 138A. In some instances, the one or more elements of merchant data 222 may include, but are not limited to, an identifier of merchant 111 (e.g., a merchant name, such as “Jonathan's Travel”), a postal address associated with merchant 111 (e.g., an actual postal address, a generic postal address, etc.), and information that identifies a financial services account associated with merchant 111 and capable of receiving proceeds from one or more of the purchased transactions described herein (e.g., an account number, a routing number, etc.). Further, the one or more elements of field mapping data 138A may characterize a structure, composition, or format of one or more data fields of an ISO-20002-compliant RFP message, such as those described herein, and additionally, or alternatively, an RFP message compliant with another standardized data-exchange protocol.

Executed RTP engine 216 may parse purchase request 206 and obtain the one or more elements of transaction data 210 that specify the parameter values characterizing the initiated purchase transaction, and elements of payment data 212 that specify the particular payment instrument selected to fund the initiated purchase transaction. In some instances, based on portions of the elements of transaction data 210, payment data 212, customer data 218, and merchant data 222, executed RTP engine 216 may perform any of the exemplary processes described herein to generate a request-for-payment (RFP) message 226 that is structured and formatted in accordance with the one or more elements of field mapping data 138A and that requests a payment from user 101 for the initiated purchase transaction (e.g., the $905.00 purchase of the economy-class airline tickets at 9:30 a.m. on December 1^{st}) not at a close of a corresponding business or calendar day, but instead in real-time and contemporaneously with the initiation of the purchase transaction by client device 102. As described herein, RFP message 226 may be structured in accordance with the ISO 20022 standard for electronic data exchange between financial institutions, and in some examples, RFP message 226 may correspond to a pain.013 message as specified within the ISO 20022 standard. Further, and as described herein, the one or more elements of field mapping data 138A may characterize a structure, composition, or format of one or more data fields of ISO-20002-compliant RFP message 226 (e.g., the one or more data fields within the pain.013 message).

By way of example, ISO-20022-compliant RFP message 226 may include among other things: (i) message fields populated with data specifying a full name and postal address of user 101; (ii) message fields populated with data identifying a payment instrument selected by user 101 to fund the initiated purchase transaction; (iii) message fields populated with data specifying a name and postal address of merchant 111; (iv) message fields populated with data identifying a financial services account held by merchant 111 and available to receive processed from the requested payment; and (v) message fields populated with one or more parameter values that characterize the initiated purchase transaction, a requested payment method, and/or a requested payment date. Further, ISO-20022-compliant RFP message 226 may also include one or more structured or unstructured message fields that specify additional information associated with the initiated purchase transaction.

Examples of the additional information include, but are not limited to, information identifying a product or service involved in the initiated purchase transaction, or a link to remittance data associated with the initiated transaction (e.g., a link to a PDF or HTML invoice identifying merchant 111 or the purchased products or services). In some instances, as described herein, the link may include a long-form uniform resource locator (URL) into which certain elements of positional or customer data may be embedded, such as, but not limited to, the actual postal code of merchant 111 or the unique identifier of user 101. In other instances, the link may include a shortened URL, such as a tiny URL, actionable by Fl computing system 130 using any of the exemplary processes described herein.

In some instances, executed RTP engine 216 may parse the elements of transaction data 210, payment data 212, customer data 218, and merchant data 222, and may perform that populate the message fields of RFP message 226 with corresponding elements of elements of transaction data 210, payment data 212, customer data 218, and merchant data 222 in accordance with field mapping data 138A. For example, executed RTP engine 216 may parse transaction data 210 and obtain data that specifies a requested payment date (e.g., Dec. 1, 2020), a requested payment amount (e.g., the $905.00 total purchase price), and a currency associated with that requested payment amount (e.g., U.S. dollars). Executed RTP engine 216 may also format the requested payment data, the requested payment amount, and the requested payment current in accordance with portions of field mapping data 138A. As illustrated in FIG. 2B, executed RTP engine 216 may perform operations that populate message field 228 of RFP message 226 with the formatted payment date (e.g., “2020-12-01”) and message fields 230 of RFP message 226 with respective ones of the formatted payment amount (e.g., “905.00”) and formatted payment current (e.g., “USD”).

Further, executed RTP engine 216 may parse the elements of customer data 218 to obtain a name of user 101 (e.g., “John Q. Stone”) and a postal address associated with user 101 (e.g., “2223 Eye Street NW, Washington, D.C., 20037, US”), and may parse the elements of payment data 212 to obtain information that identifies (e.g., an “identification” of) the payment instrument selected by user 101 to fund the purchase transaction (e.g., the account number “XXXX-1234-5678-9012”). In some instances, executed RTP engine 216 may format the obtained customer name, the obtained customer address, and the obtained identification of the payment instrument in accordance with portions of field mapping data 138A, and as illustrated in FIG. 2B, executed RTP engine 216 may perform operations that populate message fields 232 of RFP message 226 with respective portions of the formatted customer name and customer address, and that populate message field 234 with the formatted identification of the selected payment instrument.

Executed RTP engine 216 may also parse the elements of merchant data 222 to obtain a name of merchant 111 (e.g., “Jonathan's Travel”), a postal address associated with merchant 111 (e.g., “403 Army-Navy Drive, Arlington, Va., 22202, US”), and that identifies a financial services account associated with merchant 111 and capable of receiving proceeds from one or more of the purchased transactions (e.g., the account number “XXXX-9012-3456-7890”). In some instances, executed RTP engine 216 may format the obtained merchant name, the obtained merchant address, and the obtained identification of the merchant account in accordance with portions of field mapping data 138A, and as illustrated in FIG. 2B, executed RTP engine 216 may perform operations that populate message fields 236 of RFP message 226 with respective portions of the formatted merchant name and merchant address, and that populate message field 238 with the formatted identification of the merchant account.

Further, and as described herein, RFP message 226 may also include one or more message fields that specify remittance information associated with the initiated purchase transaction, such as, but not limited to, a link to a PDF or HTML invoice identifying merchant 111, a postal address associated with merchant 111, or the purchased products or services. For example, and upon receipt of purchase request 206, merchant computing system 110 (e.g., via executed RTP engine 216 or one or more other executed application programs, engines, or modules) may generate one or more elements of formatted invoice data 240 that identify merchant 111 (e.g., “Jonathan's Travel”), a postal address associated with merchant 111 (e.g., “403 Army-Navy Drive, Arlington, Va., 22202, US”), and one or more elements of transaction data 210 (e.g., names and/or UPCs of the purchased airline tickets, the $825.00 subtotal of the purchase transaction, the $80.00 sales tax, the $905.00 total purchase amount, etc.) or payment data 212 (e.g., a tokened portion of the account number of the selected payment instrument, etc.).

In some instances, the elements of formatted invoice data 240 may also include additional information, such as contextual data 243, that further characterizes the purchased products or services. For example, and for the three, economy-class airline tickets purchased to depart from Toronto, Canada, to Orlando, Fla., on Dec. 13, 2021, and to return from Orlando, Fla., on Jan. 4, 2022, contextual data 243 may include, but is not limited to, the departure and return dates (e.g., Dec. 13, 2021, and Jan. 4, 2022, respectively), the destination city or airport (e.g., Orlando, Fla.), flight times and flights number for the departure and return flights, seat numbers for the purchased, economy-class tickets, or an identifier of one or more airlines associated with the purchased economy-class tickets (e.g., an airline name, etc.). Merchant computing system 110 may perform operations that store the elements of formatted invoice data 240 within a portion of data repository 220, along with corresponding elements of linking data 242 that include, among other things, a long-form or shortened URL associated with formatted invoice data 240 (e.g., that points to the storage location of formatted invoice data 240 within data repository 220).

In some instances, executed RTP engine 216 may perform operations that obtain linking data 242 from data repository 220, and that process and package all, or a selected portion, of linking data 242 within a corresponding unstructured message field of RFP message 226. For example, linking data 242 may include a long-form URL that points to formatted invoice data 240 maintained within data repository 220 and includes the actual postal code of merchant 111 (e.g., “22202”) and the customer identifier of user 101 (e.g., http://www.Jonathan'sTravel.com/receipt?custid=‘1234’?zip=‘22202’), and as illustrated in FIG. 2B, executed RTP engine 216 may parse linking data 242, obtain the long-form URL, and package the long-form URL into an unstructured message field 244 of RFP message 226. The disclosed embodiments are, however, not limited to RFP messages populated with these exemplary elements of customer, merchant, payment, transaction, and additional remittance data, and in other examples, RFP message 226 may include any additional, or alternate, message fields specified within field mapping data 138A and consistent with the ISO 20022 standard for electronic data exchange, and executed RTP engine 216 may populate these message fields with any additional, or alternate, structured and formatted elements of customer, merchant, payment, transaction, or additional remittance data appropriate to RFP message 226 and field mapping data 138A.

As described herein, RFP message 226 may be associated with a real-time payment of $905.00 requested from user 101 by merchant 111 for purchase of the three, economy-class tickets purchased on Dec. 1, 2021. By way of example, RFP message 226 may include, but is not limited to, a message field populated with data specifying the requested payment date of Dec. 1^{st} (e.g., message field 228 of FIG. 2B) and message fields populated within data specifying the requested payment amount of US $905.00 (e.g., message fields 230 of FIG. 2B). RFP message 226 may also include, but is not limited to, message fields populated with data that identify and characterize user 101 (e.g., message fields 232 of FIG. 2B) and merchant 111 (e.g., message fields 236 of FIG. 2B), along with additional message fields populated with data that identify the payment instrument selected by user 101 to fund the purchase transaction (e.g., message field 234 of FIG. 2B) and the financial services account associated with merchant 111 and capable of receiving proceeds from the purchase transaction (e.g., message field 238 of FIG. 2B). Further, and as described herein, RFP message 226 may include one or more additional data fields populated with structured or unstructured remittance data, such as, but not limited to, a long-form URL that points to formatted invoice data 240 maintained within data repository 220 (e.g., message field 244 of FIG. 2B, which may include the long-form URL http://www.Jonathan'sTravel.com/receipt?custid=‘1234’?zip=‘22202’). The disclosed embodiments are, however, not limited to structured or unstructured remittance data that includes a long-form URL, and in other instances, the structured or unstructured remittance data may include one or more identifiers (e.g., UPCs, etc.) of the purchased products or a shortened URL that points to formatted invoice data 240.

As illustrated in FIG. 2A, executed RTP engine 216 may perform operations that cause merchant computing system 110 to broadcast now-populated RFP message 226 across communications network 120 to one or more computing systems or devices 246 within environment 100 that are associated with participants in the RTP ecosystem, such as, but not limited to, FI computing system 130 or client device 102. For example, merchant computing system 110 to broadcast now-populated RFP message 226 across network 120 directly to FI computing system 130, although in other examples, merchant computing system 110 to broadcast now-populated RFP message 226 across network 120 to one or more intermediate computing systems, such as, but not limited to, one or more computing systems associated with a clearinghouse or with a financial institution associated with merchant 111. Further, in some instances, and prior to broadcasting now-populated RFP message 226 cross communications network 120, executed RTP engine 216 may perform operations that encrypt RFP message 226 using a corresponding encryption key, and examples of the corresponding encryption key include, but are not limited to, a public cryptographic key associated with FI computing system 130. Further, executed RTP engine 216 may perform operations that cause merchant computing system 110 to broadcast now-populated RFP message 226 directly across network 120

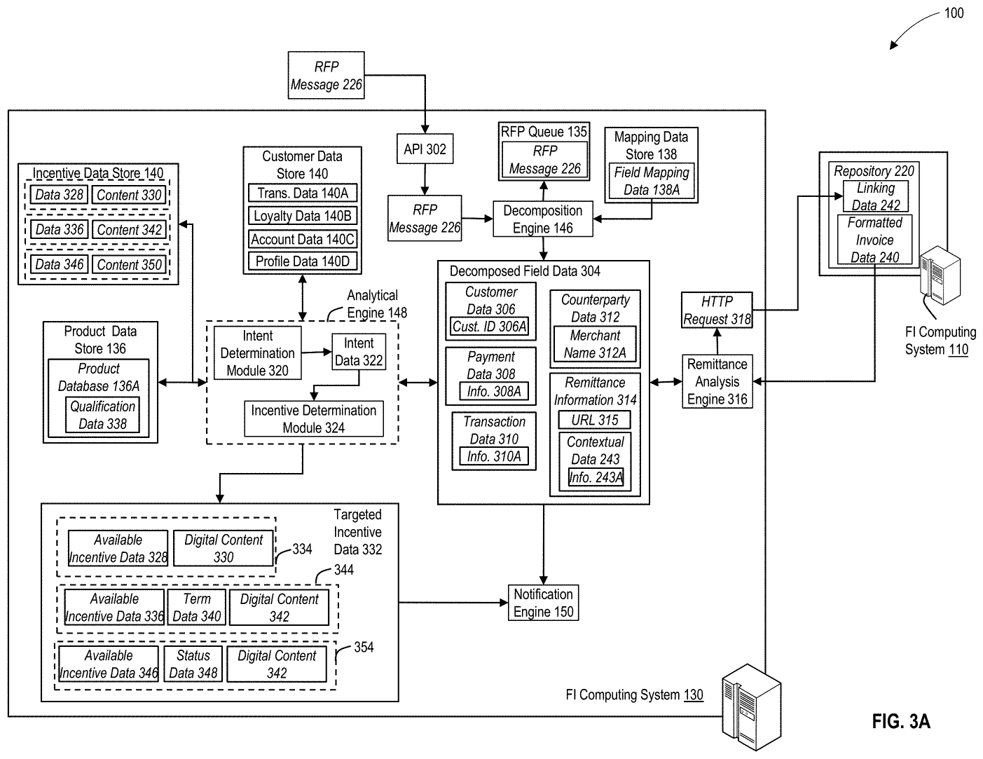

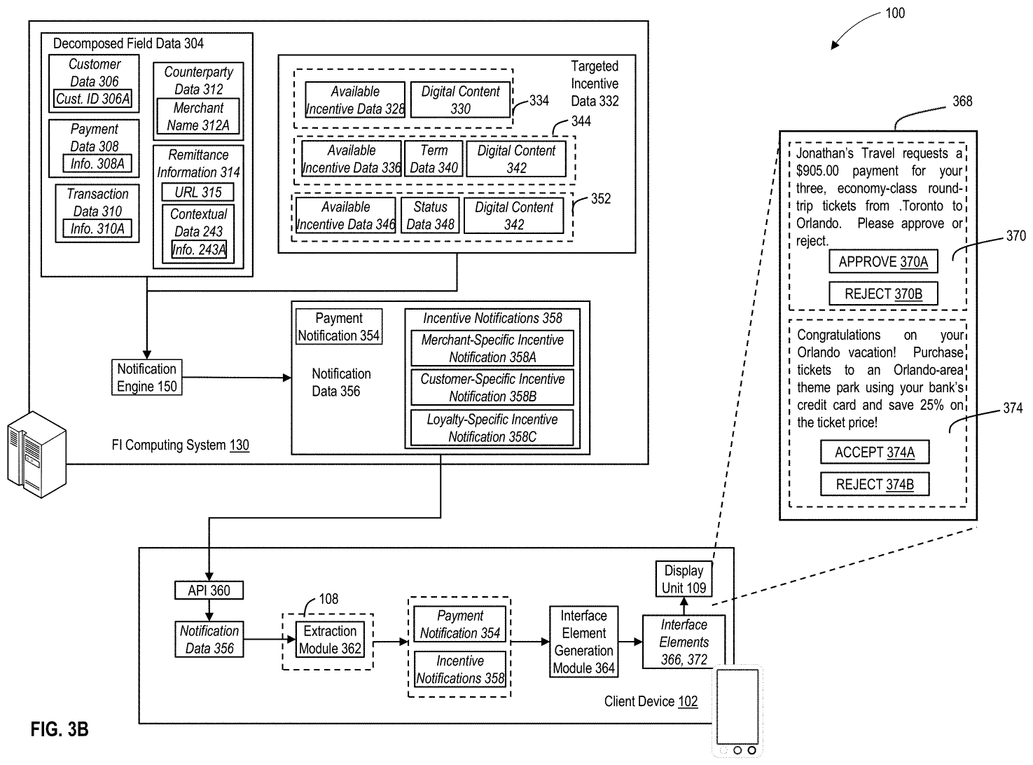

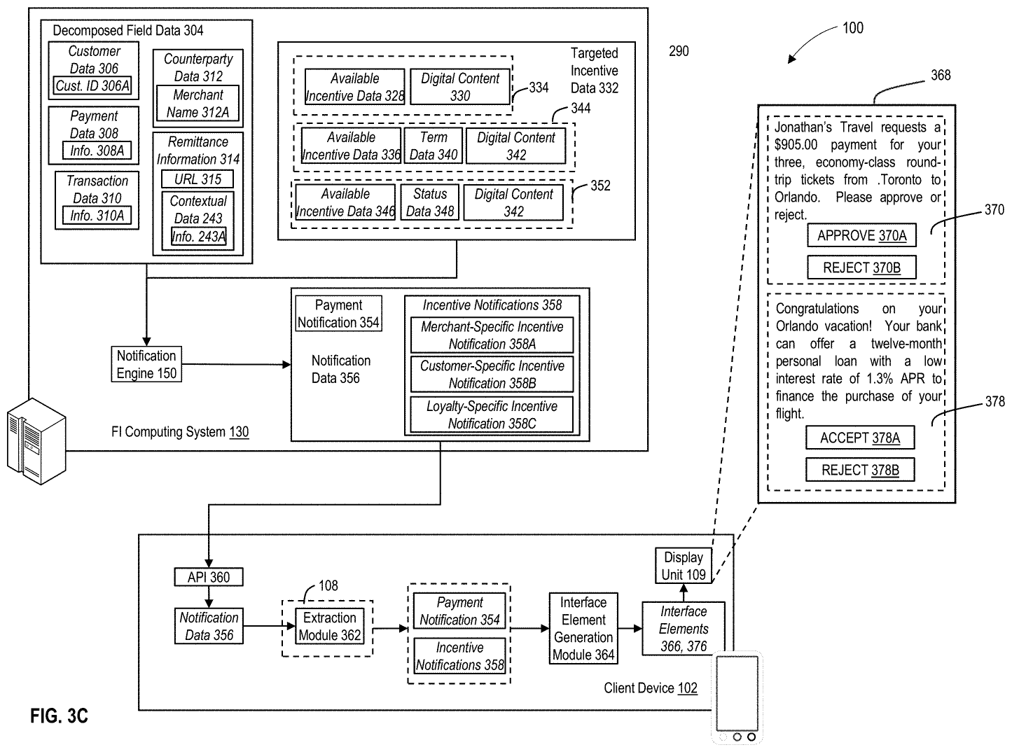

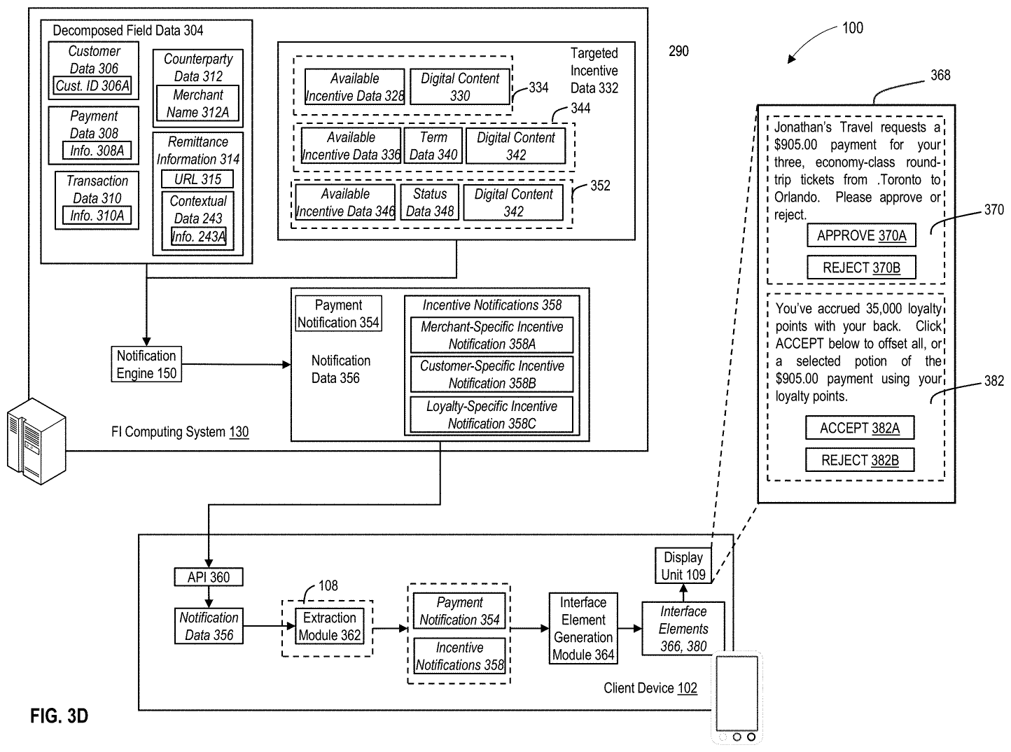

Referring to FIG. 3A, programmatic interface established and maintained by FI computing system 130, such as application programming interface (API) 302, may receive RFP message 226 (e.g., directly from merchant computing system 110 or from the one or more intermediate computing systems across a programmatically established channel of communications), and may route RFP message 226 to a decomposition engine 146 executed by the one or more processors of FI computing system 130. In some examples, one or more portions of RFP message 226 may be encrypted (e.g., using a public cryptographic key associated with FI computing system 130), and executed decomposition engine 146 may perform operations that access a corresponding decryption key maintaining within the one or more tangible, non-transitory memories of FI computing system 130 (e.g., a private cryptographic key associated with FI computing system 130), and that decrypt the encrypted portions of RFP message 226 using the corresponding decryption key. In some instances, executed decomposition engine 146 may store RFP message 226 (in decrypted form) within a corresponding portion of data repository 134, e.g., within RFP queue 135.

As described herein, RFP message 226 may be structured and formatted in accordance with the one or more elements of field mapping data 138A and that requests a payment from user 101 for a product or a service purchased by a user 101 from, for example, merchant 111, such as the three, economy-class airline tickets to travel from Toronto, Canada, to Orlando, Fla., on Dec. 13, 2021, and to return from Orlando, Florida on Jan. 4, 2022 purchased from user 101 from Jonathan's travel. For example, RFP message 226 may be structured in accordance with the ISO 20022 standard for electronic data exchange between financial institutions, and in some examples, RFP message 226 may correspond to a pain.013 message as specified within the ISO 20022 standard. Further, and as described herein, the one or more elements of field mapping data 138A may characterize a structure, composition, or format of one or more data fields of ISO-20002-compliant RFP message 226 (e.g., the one or more data fields within a pain.013 message).

As illustrated in FIG. 3A, executed decomposition engine 146 may also perform operations that access mapping data store 138 (e.g., as maintained within data repository 134), and obtain one or more elements of field mapping data 138A that characterize the structure, composition, or format of one or more data fields of RFP message 226 (e.g., the message fields consistent with the ISO 20022 standard for electronic data exchange between financial institutions). Based on the obtained elements of field mapping data 138A, executed decomposition engine 146 may perform any of the exemplary processes described herein to that parse RFP message 226 and obtain elements of decomposed field data 304 that identify and characterize user 101, merchant 111, the purchased products or services (e.g., the three, economy-class airline tickets), and the real-time payment requested from user 101 by merchant 111. In some instances, and through the performance of these exemplary operations, executed decomposition engine 146 may “decompose” the structured or unstructured data populating the message fields of RFP message 226 in accordance with field mapping data 138A, and generate the elements of decomposed field data 304 that include, but are not limited to, one or more elements of customer data 306, payment data 308, transaction data 310, counterparty data 312, and remittance information 314.

By way of example, and based on the elements of field mapping data 138A, executed decomposition engine 146 may determine that message fields 232 of RFP message 226 include data that identifies and characterizes user 101, and may perform operations that obtain the customer name of user 101 (e.g., “John Q. Stone”) and the postal address associated with user 101 (e.g., “2223 Eye Street NW, Washington, D.C., 20037, US”) from message fields 232 of RFP message 226, and that package the obtained customer name and postal address into corresponding portions of customer data 306 of decomposed field data 304. Additionally, and based on the elements of field mapping data 138A, executed decomposition engine 146 may determine that message fields 236 of RFP message 226 includes data identifying and characterizing the merchant 111, and may perform operations that obtain the name of merchant 111 (e.g., “Jonathan's Travel”) and the postal address associated with merchant 111 (e.g., “403 Army-Navy Drive, Arlington, Va., 22202, US”) from message fields 236, and that package the obtained name and postal address of merchant 111 into corresponding portions of counterparty data 312 within decomposed field data 304.

In some instances, and based on the elements of field mapping data 138A, executed decomposition engine 146 may determine that one or more additional message fields of RFP message 226 include elements of data identifying and characterizing the requested payment, such as, but not limited to: message field 228, which includes the requested payment date (e.g., “Dec. 1, 2021”); message fields 230, which includes data identifying the payment amount of the requested payment (e.g., $905.00) and the requested payment currency (e.g., “USD”); message field 234, which includes an identifier of the payment instrument selected by user 101 to fund the initiated purchase transaction (e.g., the account number “XXXX-1234-5678-9012”); and message field 238, which includes an identifier of an account associated with merchant 111 and available of receiving the requested payment (e.g., the tokenized account number “XXXX-9012-3456-7890,” etc.). Executed decomposition engine 146 may perform operations that extract the payment amount, the account identifier, and the requested payment date from corresponding ones of message fields 228, 230, and 238, and that package the extracted payment amount, the identifiers of the selected payment instrument and the account associated with merchant 111, and the requested payment date into corresponding portions of payment data 308.

Further, and based on the elements of field mapping data 138A, executed decomposition engine 146 may also determine that one or more additional, or alternate, message fields of RFP message 226 (not illustrated in FIG. 2B) include elements of transaction data that characterize the initiate purchase transaction, e.g., the purchase of the three, economy-class airline tickets to travel from Toronto, Canada, to Orlando, Fla., on Dec. 13, 2021, and to return from Orlando, Fla. on Jan. 4, 2022 purchased from user 101 from Jonathan's travel. By way of example, the transaction data maintained within the additional, or alternate, message fields of RFP message 226 may include one or more identifiers of the purchased airline tickets (e.g., a ticket name, a corresponding UPC code, etc.), the $750.00 ticket price of the purchased airline tickets, the $75.00 in fees imposed on the ticket price, and the $825.00 subtotal of the initiated purchase transaction, and the $80.00 in local sales tax. In some instances, executed decomposition engine 146 may perform operations that extract the elements of transaction data, such as, but not limited to, the exemplary elements described herein, from corresponding ones of the additional, or alternate, message fields, and package the extracted elements of transaction data into corresponding portions of transaction data 210 of decomposed field data 304.

Executed decomposition engine 146 may also determine, based on the elements of field mapping data 138A, that message field 244 of RFP message 226 includes structured or unstructured elements of remittance data that characterizes further the requested payment, user 101, or merchant 111, and executed decomposition engine 146 may obtain the structured or unstructured elements of remittance data from message field 244 of RFP message 226 and package the obtained elements of remittance data into corresponding portions of remittance information 314. In some instances, the elements of structured or unstructured remittance data may include a link (e.g., a shortened or tiny URL, a long-form URL, etc.) to formatted invoice data associated with the requested payment and maintained by merchant computing system 110. For example, the remittance data may include a long-form URL (e.g., http://www.Jonathan'sTravel.com/receipt?custid=‘1234’?zip=‘22202’), that points to formatted invoice data 240 within data repository 220 of merchant computing system 110, and that includes, among other things, the actual postal code of merchant 111 (e.g., “22202”) and the customer identifier of user 101. Executed decomposition engine 146 may obtain the shortened or long-form link from message fields of RFP message 226, and package the shortened or long-form link into remittance information 314, e.g., as URL 315.

In some instances, the one or more processors of FI computing system 130 may execute a remittance analysis engine 316, which may perform operations that, based on URL 315 maintained within remittance information 314 of decomposed field data 304, programmatically access elements of formatted invoice data 240 maintained at merchant computing system 110, and that process the accessed elements of formatted invoice data 240 to obtain additional, or alternate, elements of customer data 306, payment data 308, transaction data 310, counterparty data 312, and additionally, or alternatively, one or more elements of contextual data 243 that further characterizes the purchased products or services associated with the requested, real-time payment., e.g., the three, economy-class airline tickets purchased to depart from Toronto, Canada, to Orlando, Fla., on Dec. 13, 2021, and to return from Orlando, Fla., on Jan. 4, 2022. For example, remittance analysis engine 316 may access URL 315 maintained within remittance information 314 (e.g., long-form URL http://www.Jonathan'sTravel.com/receipt?custid=‘1234’?zip=‘22202’,” as described herein, etc.), and may process URL 315 and generate a corresponding HTTP request 318 for the elements of formatted invoice data 240 maintained at merchant computing system 110. Executed remittance analysis engine 216 may also perform operations that cause FI computing system 130 to transmit HTTP request 318 across network 120 to merchant computing system 110.

Merchant computing system 110 may, for example, receive HTTP request 318, and based on portions of HTTP request 318 and linking data 242 maintained within data repository 220 (e.g., based on a determined match or correspondence between the portions of HTTP request 318 and linking data 242), Merchant computing system 110 may perform operations that obtain the elements of formatted invoice data 240 from data repository 220, and that transmit the elements of formatted invoice data 240 across network 120 to FI computing system 130, e.g., as a response to HTTP request 318. Further, as illustrated in FIG. 3A, executed remittance analysis engine 316 may receive the elements of formatted invoice data 240 from merchant computing system 110, and may perform any of the exemplary processes described herein to parse the elements of formatted invoice data 240 (e.g., in a received format, such as a PDF or HTML form, or in a transformed or enhanced format, etc.) and obtain, from the parsed elements of formatted invoice data 240, one or more of the additional, or alternate, elements of customer data 306, payment data 308, transaction data 310, or counterparty data 312 and in some instances, one or more elements of contextual data 243. By way of example, executed remittance analysis engine 216 may apply one or more optical character recognition (OCR) processes or optical word recognition (OWR) processes to the elements of formatted invoice data 240 in PDF form to generate, or obtain, elements of textual content representative of the data that characterize user 101, merchant 111, the requested payment, or the initiated purchase of the airline tickets.

By way of example, executed remittance analysis engine 216 may perform operations that detect a presence one or more keywords within the generated elements of textual content (e.g., “return,” “depart,” “flight,” “airline,” etc.), and may extract elements of the textual content associated with these keywords as corresponding ones of the additional, or alternate, elements of customer data 306, payment data 308, transaction data 310, or counterparty data 312. In other examples, executed remittance analysis engine 216 may detect a presence of the additional, or alternate, elements of customer data 306, payment data 308, transaction data 310, or counterparty data 312 within the generated textual content based on an application of one or more adaptively trained machine learning or artificial intelligence models to portions of the textual content, and examples of these adaptively trained machine learning or artificial intelligence models includes a trained neural network process (e.g., a convolutional neural network, etc.) or a decision-tree process that ingests input datasets composed of all, or selected portions, of the textual content. The disclosed embodiments are, however, not limited to exemplary processes for detecting and extracting one or more of the additional, or alternate, elements of data 306, payment data 308, transaction data 310, or counterparty data 312 from the generated textual content, and in other instances, executed remittance analysis engine 316 may perform any additional, or alternate, process for identifying one or more of the additional, or alternate, elements of customer data 306, payment data 308, transaction data 310, or counterparty data 312 within the textual content derived from the processing of the elements of formatted invoice data 240 in PDF format.

Further, and as described herein, the elements of formatted invoice data 240 may be structured in HTML form, and may include metadata that identify and characterize user 101 (e.g., the customer name, etc.), merchant 111 (e.g., the name or other identifier, etc.), the requested payment (e.g., a payment amount, etc.), or the initiated purchase of the airline tickets. Executed remittance analysis engine 316 may perform operations that detect one or more of the elements of metadata within the elements of formatted invoice data 240, and that obtain, from the elements of metadata, additional, or alternate, elements of customer data 306, payment data 308, transaction data 310, or counterparty data 312, as described herein. The disclosed embodiments are, however, not limited to these exemplary processes for detecting and extracting the additional, or alternate, elements of customer data 306, payment data 308, transaction data 310, or counterparty data 312 from HTML-formatted receipt data, and in other instances, executed remittance analysis engine 316 may perform any additional, or alternate, process detecting and obtaining data from the elements of formatted invoice data 240 structured in HTML form, including, but not limited to, an application of one or more screen-scraping processes to elements of formatted invoice data 240 structured in HTML form.

In some instances, executed remittance analysis engine 316 may also perform any of the exemplary operations described herein to process the elements of formatted invoice data 240, structured in PDF or HTML form, and extract one or more elements of contextual data 243 that further characterize the three, economy-class airline tickets purchased to depart from Toronto, Canada, to Orlando, Fla., on Dec. 13, 2021, and to return from Orlando, Fla., on Jan. 4, 2022. By way of example, the extracted elements of contextual data 243 may include, but are not limited to, the departure and return dates (e.g., Dec. 13, 2021, and Jan. 4, 2022, respectively), the destination city or airport (e.g., Orlando, Fla.), flight times and flights number for the departure and return flights, seat numbers for the purchased, economy-class tickets, or an identifier of one or more airlines associated with the purchased economy-class tickets (e.g., an airline name, etc.). Merchant computing system 110 may perform operations that store the elements of contextual data 243 within a portion of remittance information 314.

In some instances, executed decomposition engine 146 may perform operations that store decomposed field data 304, which includes the element of customer data 306, payment data 308, transaction data 310, or counterparty data 312, and remittance information 314 (including URL 315 and contextual data 243), within a corresponding portion of data repository 134 (not illustrated in FIG. 3A), and may provide decomposed field data 304 as an input to analytical engine 148 of FI computing system 130. Upon execution by the one or more processors of FI computing system 130, executed analytical engine 148 may perform any of the exemplary processes described herein to generate elements of intent data that characterize a customer intent associated with the initiated purchase transaction, and based on determined customer intent, that generate or obtain elements of digital content characterizing one or more targeted offers or incentives to client device 102. As described herein, examples of these targeted offers or incentives may include, but are not limited to, or more merchant-, customer-, and/or loyalty-based offers or incentives associated with user 101 or the initiated purchase transaction, an offer to provision, to user 101, a financial product capable of financing all or a portion of the initiated purchase transaction (e.g., an unsecured personal loan, an installment loan, etc.).

By way of example, an intent determination module 320 of executed analytical engine 148 may access decomposed field data 304, and based on the elements of customer data 306, payment data 308, transaction data 310, or counterparty data 312, the extracted elements of contextual data 243, and the elements of transaction data 140A, account data 140C, or customer profile data 140D, generate one or more elements of intent data 322 that characterize a customer intent associated with the initiated purchase transaction, e.g., the $905.00 purchase of the three, economy-class airline tickets. In some instances, executed intent determination module 320 may access customer data 306, and obtain a unique customer identifier 306A of user 101, such as, but not limited to, a customer name (e.g., “John Q. Stone”) or an alphanumeric login credential associated with user 101. Further, executed intent determination module 320 may access payment data 308, transaction data 310, and counterparty data 312, and obtain corresponding ones of payment information 308A that includes, among other things, the $905.00 payment amount and the requested payment date of Dec. 1, 2021, transaction information 310A that, includes, among other things, a quantity of the purchased airline tickets and a unique identifier of the purchase airline tickets (e.g., a UPC assigned to the airline tickets, etc.), and a merchant name 312A of merchant 111 (e.g., merchant name “Jonathan's Travel). Further, executed intent determination module 320 may access contextual data 243, and obtain contextual information 243A that includes, among other things, the departure and return dates (e.g., Dec. 23, 2021, and Jan. 4, 2022, respectively), the destination city or airport (e.g., Orlando, Fla.), flight times and flights number for the departure and return flights, seat numbers for the purchased, economy-class tickets, or an identifier of one or more airlines associated with the purchased economy-class tickets (e.g., an airline name, etc.).

In some instances, executed intent determination module 320 may perform operations that analyze customer identifier 306A, merchant name 312A, payment information 308A, transaction information 310A, and contextual information 243A, either alone or in conjunction with elements of transaction data 140A, account data 140C, or customer profile data 140D associated with user 101, to determine, among other things, the user 101 is a member of a three-person family having a child, and that the customer intent associated with the initiated purchase transaction corresponds to a purchase of economy-class airline tickets in support of a family vacation to Orlando, Florida during a winter break from school. In some instances, executed intent determination module 320 may perform operations that generate elements of intent data 322 that characterize the now-determined customer intent, and that provision the elements of intent data 322 as an input to an incentive determination module 324 of executed analytical engine 148, which may perform any of the exemplary processes described herein to generate elements of incentive data 326 that identify and characterize one, or more, targeted offers or incentives associated with the initiated purchase transaction and consistent with the determined customer intent.

By way of example, executed intent determination module 320 may perform operations that apply a trained machine learning or artificial intelligence process to an input dataset obtained, or extracted from, portions of customer identifier 306A, merchant name 312A, payment information 308A, transaction information 310A, or contextual information 243A, and one or more of the elements of transaction data 140A, account data 140C, or customer profile data 140D associated with user 101, and based on the application of the trained machine learning or artificial intelligence process to the input dataset, executed intent determination module 320 may generate one or more elements of intent data 322 that characterize a customer intent associated with the initiated purchase transaction. Examples of the trained machine-learning and artificial-intelligence processes may include, but are not limited to, a clustering process, an unsupervised learning process (e.g., a k-means algorithm, a mixture model, a hierarchical clustering algorithm, etc.), a semi-supervised learning process, a supervised learning process, or a statistical process (e.g., a multinomial logistic regression model, etc.). The trained machine-learning and artificial-intelligence processes may also include, among other things, a decision tree process (e.g., a boosted decision tree algorithm, etc.), a random decision forest, an artificial neural network, a deep neural network, or an association-rule process (e.g., an Apriori algorithm, an Eclat algorithm, or an FP-growth algorithm). Further, and as described herein, each of these exemplary machine-learning and artificial-intelligence processes may be trained against, and adaptively improved using, elements of training and validation data, and may be deemed successfully trained and ready for deployment when a value of one or more performance or accuracy metrics are consistent with one or more threshold training or validation criteria.

For instance, the trained machine learning or artificial intelligence process may include a trained decision-tree process, and executed intent determination module 320 may obtain, from one or more tangible, non-transitory memories, elements of process input data and process parameter data associated with the trained decision-tree process (not illustrated in FIG. 3A). For example, the elements of process input data may characterize a composition of the input dataset for the trained decision-tree process and identify each of the discrete data elements within the input data set, along with a sequence or position of these elements within the input data set, and the elements of process parameter data may include a value for one or more parameters of the trained decision-tree process. Examples of these parameter values include, but are not limited to, a learning rate associated with the trained, decision-tree process, a number of discrete decision trees included within the trained, decision-tree process, a tree depth characterizing a depth of each of the discrete decision trees, a minimum number of observations in terminal nodes of the decision trees, and/or values of one or more hyperparameters that reduce potential process overfitting.

In some examples, not illustrated in FIG. 3A, executed intent determination module 320 may perform operations that generate one or more discrete elements (e.g., “feature values”) of the input dataset in accordance with the elements of process input data and based on the portions of customer identifier 306A, merchant name 312A, payment information 308A, transaction information 310A, or contextual information 243A, and one or more of the elements of transaction data 140A, account data 140C, or customer profile data 140D associated with user 101. Based on portions of the process parameter data, executed intent determination module 320 may perform operations that establish a plurality of nodes and a plurality of decision trees for the trained decision-tree process, each of which receive, as inputs (e.g., “ingest”), corresponding elements of the input dataset. Further, and the ingestion of the input dataset by the established nodes and decision trees of the trained decision-tree process, executed intent determination module 320 may perform operations that apply the trained, decision-tree process to the input dataset, and that generate the one or more elements of intent data 322 that characterize a customer intent associated with the initiated purchase transaction.

Referring back to FIG. 3A, executed incentive determination module 324 may receive the elements of intent data 322, and may perform operations that obtain, among other things, customer identifier 306A of user 101 from customer data 306 of decomposed field data 304. In some instances, executed incentive determination module 324 access incentive data store 142 (e.g., as maintained within data repository 134), and may parse the structured or unstructured data records of incentive data store 142 to identify one or more data records that include or reference customer identifier 306A (or an additional customer identifier, such as an alphanumeric login credential, associated with customer identifier 306A) and as such, that identify and characterize corresponding ones of the targeted offers or incentives that are available for provisioning to user 101. As described herein, examples of these targeted offers or incentives may include, but are not limited to, or more merchant-, customer-, and/or loyalty-based offers or incentives associated with user 101 or the initiated purchase transaction, including an offer to provision, to user 101, a financial product capable of financing all or a portion of the initiated purchase transaction (e.g., an unsecured personal loan, an installment loan, etc.).

As illustrated in FIG. 3A, executed incentive determination module 324 may obtain, from incentive data store 142, one or more elements of available incentive data 328 that are associated with customer identifier 306A. In some instances, executed incentive determination module 324 may process the elements of available incentive data 328 and determine that the elements of available incentive data 328 identify and characterize with a targeted, merchant-specific offer associated with a merchant having a relationship with the financial institution. The merchant-specific offer may correspond to a predetermined discount on tickets to theme-park attractions in the Orlando, Fla., area if purchased using a credit-card account issued by the financial institution, and in some instances, executed incentive determination module 324 may perform operations that determine, based on the elements of intent data 322 and the obtained elements of available incentive data 328, that the merchant-specific offer is associated with the initiated purchase transaction and with the customer intent of the initiated purchase transaction, e.g., the purchase of the economy-class airline tickets in support of the family vacation to Orlando, Florida during the winter break. In some instances, executed incentive determination module 324 may obtain one or more elements of digital content 330 associated with the merchant-specific offer, and with the elements of available incentive data 328, from incentive data store 140, and may package a portion of available incentive data 328 (e.g., that includes a URL associated with the merchant-specific offer) and the elements of digital content 330 within a corresponding portion of targeted incentive data 332, e.g., within element 334.

Further, in some examples, executed incentive determination module 324 may also perform operations that obtain, from incentive data store 142, one or more elements of available incentive data 336 that are associated with customer identifier 306A, and that characterize a targeted, customer-specific offer, by the financial institution, to provision, to user 101, an unsecured personal loan capable of financing all or a portion of the $905.00 purchase price of the three, economy-class airline tickets to travel from Toronto, Canada, to Orlando, Fla., on Dec. 13, 2021, and to return from Orlando, Florida on Jan. 4, 2022. In some instances, executed incentive determination module 324 may process the elements of available incentive data 336 and determine, based on the elements of intent data 322 and the obtained elements of available incentive data 336, that the targeted, customer-specific offer is associated with the initiated purchase transaction and with the customer intent of the initiated purchase transaction. In some instances, executed incentive determination module 324 may access product database 136A of product data store 136, and obtain elements of qualification data 338 that identify one or more one or more internal qualification or underwriting procedures associated with a provisioning of the unsecured personal loan to user 101.

In some instances, and based on the elements of qualification data 338, executed incentive determination module 324 may perform operations that apply the one or more internal qualification or underwriting procedures to elements of transaction data 140A, account data 140C, and customer profile data 140D associated with user 101, and to additional elements of data characterizing user 101's interactions with the financial institution associated with FI computing system 130 and with other financial institutions, and a use, or misuse, of financial products or services provisioned to user 101 by the financial institution or by the other financial institution. The additional elements of data may include, but are not limited to, one or more elements of reporting data maintained by a corresponding credit bureau or other reporting entity, and the elements of reporting data may include, but are not limited to, a credit score assigned to user 101 by the credit bureau or reporting entity or a number of credit inquiries associated with user 101 during one or more temporal intervals. In some instances, and based on an application of the one or more internal qualification or underwriting procedures to elements of transaction data 140A, account data 140C, and customer profile data 140D associated with user 101, and to the elements of reporting data associated with user 101, executed incentive determination module 324 may determine that the unsecured personal loan is available for provisioning to user 101 in an amount at least equivalent to the $905.00 purchase price of the three, economy-class airline tickets.

Executed incentive determination module 324 may also perform operations that, based on the elements of qualification data 338, determine one or more terms and conditions associated with the available, unsecured personal loan, and examples of the terms and conditions include, but are not limited to, a loan amount (e.g., the $905.00 purchase price of the three, economy-class airline tickets), an interest rate for the personal loan (e.g., 1.3% APR), a term of the unsecured personal loan (e.g., twelve months), and a minimum monthly payment across the term of the loan. In some instances, executed incentive determination module 324 may generate elements of term data 340, which identify the determined terms and conditions of the available, unsecured personal loan, and store the generated elements of term data 340 within a corresponding portion of account data 140C, along with customer identifier 306A (not illustrated in FIG. 3A). Further, executed incentive determination module 324 may perform any of the exemplary processes described herein to obtain one or more elements of digital content 342 associated with the targeted customer-specific offer to provision the unsecured, personal loan to user 101 in accordance with the determined terms and conditions, and with the elements of available incentive data 336, from incentive data store 142. Executed incentive determination module 324 may also perform operation that package at least a portion of available incentive data 336, term data 340, and the elements of digital content 342 within a corresponding portion of targeted incentive data 332, e.g., within element 344.

Further, in some examples, executed incentive determination module 324 may also perform operations that obtain, from incentive data store 142, one or more elements of available incentive data 346 that are associated with customer identifier 306A, and that characterize a targeted, loyalty-specific offer to offset all, or a customer-selected portion of, the $905.00 cost of the purchased airlines tickets using a loyalty points accrued by user 101 within a corresponding loyalty program operated by the financial institution associated with Fl computing system 130 or alternatively, by one or more merchant or retailers having a relationship with the financial institution, such as, but not limited to, the airline associated with the purchased airline tickets (e.g., an airline-sponsored frequent-flier program). In some instances, executed incentive determination module 324 may parse the elements of incentive available data 346 and obtain a program identifier of the corresponding loyalty program (e.g., the loyalty program of the financial institution), and based on the obtained program identifier and customer identifier 306A, executed incentive determination module 324 may access one or more elements of loyalty data 140B associated with user 101 and determine a current status of user 101 within the loyalty program of the financial institution.

The current status may, for example, indicate that, as of 9:30 a.m. on Dec. 1, 2020 (e.g., time or date of the initiated purchase transaction), user 101 accrued 36,550 points within the loyalty program of the financial institution, and executed incentive determination module 324 may perform operations that obtain status data 348 indicative of the accrued points from loyalty data 140B (e.g., 35,000 accrued loyalty points). Executed incentive determination module 324 may also perform operations that obtain, from incentive data store 142, one or more elements of digital content 350 associated with the elements of available incentive data 346, and with the targeted loyalty-program-specific offer to offset all, or a customer-selected portion of the total cost of the purchased airlines tickets using the loyalty points accrued by user 101 within loyalty program of the financial institution. As illustrated in FIG. 3A, executed incentive determination module 324 may perform operations that package at least a portion of available incentive data 346 (e.g., that includes a URL to a digital interface, such as a web page, that enables user 101 to offset all, or a customer-selected portion of, the $905.00 cost of the purchased airlines tickets using the accrued loyalty points), status data 348, and the elements of digital content 350 into a corresponding portion of targeted incentive data 332, e.g., within element 352.

The disclosed embodiments are, however, not limited to these exemplary merchant-, customer-, and/or loyalty-based offers or incentives associated with the initiated purchase transaction and consistent with the determined customer intent of the initiated purchase transaction. In other instances, executed incentive determination module 324 may perform any of the exemplary processes described herein to generate elements of targeted incentive data 332 that identify and characterize any additional, or alternate, merchant-, customer-, and/or loyalty-based offers or incentives that are characterized by the data records of incentive data store 142, and that are associated with user 101 and with the initiated purchased transaction and the determined customer intent of that initiated purchase transaction, e.g., the purchase of the economy-class airline tickets in support of the family vacation to Orlando, Florida during the winter break. Executed analytical engine 148 may provision targeted incentive data 332, including elements 334, 344, and 352 associated with the targeted, merchant-, customer-, and loyalty-specific offers, as an input to notification engine 150, which when executed by the one or more processors of FI computing system 130, may perform any of the exemplary processes described herein to generate a payment notification associated with the requested, real-time payment of $905.00 associated with the purchase of the three, economy-class airline tickets, and to generate an incentive notification associated with one, or more, of the targeted, merchant-, customer-, and/or loyalty-based offers consistent with the determined customer intent of the initiated purchase transaction, e.g., as characterized by corresponding ones of the elements of targeted incentive data 332.

Referring to FIG. 3B, executed notification engine 150 may receive the elements of targeted incentive data 332, including elements 334, 344, and 352 associated with the targeted, merchant-, customer-, and loyalty-specific offers. Executed notification engine 150 may also perform operations that access data repository 134, and obtain decomposed field data 304 that includes one or more elements of customer data 306, payment data 308, transaction data 310, counterparty data 312, and remittance information 314 extracted from the structured or unstructured message fields of RFP message 226 and as such, that characterize the $905.00 real-time payment from user 101 by merchant 111. In some instances, executed notification engine 150 may parse customer data 306 within decomposed field data 304 to obtain a customer identifier 306A of user 101, such as, but not limited, a full name of user 101 extracted from the message fields of the RFP message 226 (e.g., “John Q. Stone”). Further, executed notification engine 150 may also perform operations that parse payment data 308 to obtain payment information 308A that identifies the $905.00 requested payment, and, in some examples, the requested payment date, and that parse counterparty data 312 to obtain merchant name 312A (e.g., “Jonathan's Travel”). Executed notification engine 150 may perform additional operations that generate a payment notification 354 that includes the customer identifier 208, the portion of payment information 208A that specifies the $905.00 payment amount and a requested payment date (e.g., December 1^{st}), and merchant name 212A, and package payment notification 354 into a corresponding portion of notification data 356.

Further, and based on the one or more elements of customer data 306, payment data 308, transaction data 310, counterparty data 312, and remittance information 314, and based on the elements of targeted incentive data 332, executed notification engine 150 may generate one or more incentive notifications 358 that identify and characterize each of the targeted, merchant-, customer-, and loyalty-specific offers described herein. For example, as illustrated in FIG. 3A, incentive notifications 358 may include a merchant-specific incentive notification 358A associated the targeted, customer-specific offer of a predetermined discount on tickets to theme-park attractions in the Orlando, Fla., area purchased using the credit-card account issued by the financial institution, and merchant-specific incentive notification 358A may include, all, or a selected potion of element 334 of targeted incentive data 332, such as the portion of available incentive data 328 that includes the URL associated with the merchant-specific offer and the elements of digital content 330.

In some examples, incentive notifications 358 may also include a customer-specific incentive notification 358B associated with the targeted, customer-specific offer to provision an unsecured personal loan capable of financing all or a portion of the $905.00 purchase price of the three, economy-class airline tickets to user 101, and customer-specific incentive notification 358B may include, all, or a selected potion of element 344 of targeted incentive data 332, such as a portion of available incentive data 336 (e.g., that identifies the unsecured personal loan), a portion of term data 340 (e.g., that identifies the loan amount, the interest rate, the term, or the minimum monthly payment, etc.), and the elements of digital content 342. Further, in some examples, incentive notifications 358 may also include a loyalty-specific incentive notification 358C associated with the targeted, loyalty-specific offer to offset all, or a customer-selected portion of, the $905.00 cost of the purchased airlines tickets using accrued loyalty points, and loyalty-specific incentive notification 358C may include, all, or a selected potion of element 352 of targeted incentive data 332, such as a portion of available incentive data 346 (e.g., that includes a URL to the web page that enables user 101 to offset all, or a customer-selected portion of, the $905.00 cost of the purchased airlines tickets using the accrued loyalty points), status data 348 that identifies a total number of available loyalty points accrued by user 101, and the elements of digital content 350.

Executed notification engine 150 may package incentive notifications 358, including merchant-specific incentive notification 358A, and customer-specific incentive notification 358B, loyalty-specific incentive notification 358C, into corresponding portions of notification data 356. In some instances, executed notification engine 150 may perform operations that cause FI computing system 130 to transmit notification data 356, including payment notification 354 and each of incentive notifications 358, across network 120 to client device 102. A programmatic interface established and maintained by client device 102, such as application programming interface (API) 360 associated with mobile banking application 108, may receive notification data 356, and may perform operations that trigger an execution (e.g., via a programmatic command, etc.) of mobile banking application 108 by the one or more processors of client device 102, e.g., processor 104. In some instances, API 360 may route notification data 356 to an extraction module 362 of executed mobile banking application 108.

As described herein, executed extraction module 362 may receive notification data 356, which includes payment notification 354 and each of incentive notifications 358, and may perform operations that parse payment notification 354 to obtain customer identifier 306A, the portion of payment information 308A that specifies the $905.00 payment amount for the three purchased economy-class airline tickets, and merchant name 212A, which executed extraction module 362 may provide as an input to an interface element generation module 364 of executed mobile banking application 108. In some instances, executed interface element generation module 364 may perform operations that generate one or more interface elements 366 based on customer identifier 306A, the portion of payment information 308A that specifies the $905.00 payment amount for the three purchased economy-class airline tickets, and merchant name 212A, and provide interface elements 366 to display unit 109A. When rendered for presentation within notification interface 368 by display unit 109A, interface elements 366 provide a graphical representation 370 of the request for payment within a single display screen or window, or across multiple display screens or windows, of notification interface 368.

For example, interface elements 366 may, when presented within notification interface 368, provide a graphical representation of the request for the $905.00 payment for the three economy-class airline tickets purchased by user 101 from merchant 111 prior to December 1^{st}, and prompt user 101 to approve or reject the request for payment, e.g., based on additional input provided to input unit 109B of client device 102 that selects a respective one of an “APPROVE” icon 370A and a “REJECT” icon 370B presented within notification interface 368. User 101 may elect to approve the requested payment (e.g., to send payment to the second financial institution) by providing input (e.g., via input unit 109B) to select the “APPROVE” icon 370A, or may decline the requested payment by providing input to select the “REJECT” icon 370B, and client device 102 may perform operations that generate and one or more elements of a payment response indicative of the approved or decline payment, and that transmit the payment response across network 120 to FI computing system 130 (not illustrated in FIG. 3B).

In some instances, executed extraction module 362 may also perform operations that parse one or more of incentive notification 358, such as merchant-specific incentive notification 358A associated the targeted, merchant-specific offer of a predetermined discount on tickets to theme-park attractions in the Orlando, Fla., area purchased using the credit-card account issued by the financial institution, and obtain, from merchant-specific incentive notification 358A, the portion of available incentive data 328 that includes the URL associated with the merchant-specific offer and the elements of digital content 330. Executed extraction module 362 may provide the extracted portion of available incentive data 328 and the extracted elements of digital content 330 as input to executed interface element generation module 364, which may perform operations that generate additional elements 372 based on portions of available incentive data 328 and digital content 330, and that route interface elements 372 to display unit 109A.

When rendered for presentation within a corresponding notification interface 368 by display unit 109A, interface elements 372 provide a graphical representation 374 of the targeted, merchant-specific offer for the predetermined, 25% discount on the purchase price of the ticket to the theme-park attractions in the Orlando, Fla., area purchased using the credit-card account issued by the financial institution within a single display screen or window, or across multiple display screens or windows, of notification interface 368. For example, interface elements 366 may, when presented within notification interface 368, graphical representation 374 may identify the predetermined 25% discount on the theme-park tickets and present the targeted merchant-specific offer in real-time and contemporaneously with the presentation of graphical representation 370, and prompt user 101 to initiate a spur-of-the-moment purchase related to determined customer intent in real-time and contemporaneously with the approval or rejection of the requested, real-time payment of $905.00 to merchant 111, e.g., based on input provided to input unit 109B of client device 102 that selects a respective one of an “ACCEPT” icon 374A and a “DECLINE” icon 374B presented within notification interface 368.

In some instances, not illustrated in FIG. 3B, user 101 may elect to approve the requested payment (e.g., to send payment to merchant 111) by providing input (e.g., via input unit 109B) to select the “APPROVE” icon 370A, or may decline the requested payment by providing input to select the “REJECT” icon 370B, and client device 102 may perform operations that generate and one or more elements of a payment confirmation indicative of the approved or decline payment, and that transmit the payment response across network 120 to FI computing system 130. Further, although not illustrated in FIG. 3B, executed RTP engine 152 may receive the payment response, and based on a determination that user 101 approved the $905.00 requested by merchant 111 for the purchased, economy-class airline tickets, RTP engine 152 may, upon execution by the one or more processors of FI computing system 130, perform operations that debit the approved $905.00 payment from the account selected by user 101 to fund the initiated purchase transaction, e.g., as maintained within customer data 306 of decomposed field data 304.

Executed RTP engine 152 may perform operations (not illustrated in FIG. 3B) that access data repository 134, and obtain decomposed field data 304 that includes one or more elements of customer data 306, payment data 308, transaction data 310, counterparty data 312, and remittance information 314 extracted from the structured or unstructured message fields of RFP message 226 and, as such, that characterize the requested $905.00 payment from user 101 by merchant 111 and the initiated purchase transaction involving the three, economy-class airline tickets. Executed RTP engine 152 may, based on the one or more elements of customer data 306, payment data 308, transaction data 310, counterparty data 312, and remittance information 314, generate a response to RFP message 226 that confirms the approved $905.00 payment by user 101 and the debiting of the $905.00 from the selected account of user 101. For example, the response may include message fields consistent with the ISO 20022 standard for electronic data exchange between financial institutions, and each of the message fields may be populated with data structured and formatted in accordance with the ISO 20022 standard. In some instances, not illustrated in FIG. 3B, executed RTP engine 152 may perform operations that cause FI computing system 130 to transmit the response across network 120 to merchant computing system 110, either directly or through one or more intermediate computing systems associated with a clearinghouse or a financial institution of merchant 111, and executed RTP engine 152 may also perform operations that access RFP message 226 maintained within RFP queue 135, and delete RFP message 226 from RFP queue 135.

Referring back to FIG. 3B, and upon viewing graphical representation 374, user 101 may elect to purchase one or more discounted tickets to the Orlando-area theme parks in accordance with the targeted, merchant-specific offer, and user 101 may provide input to client device 102 (e.g., via input unit 109B) that selects “ACCEPT” icon 374A presented within notification interface 368. Based on the selection of icon 374A, input unit 109B may route corresponding elements of input data indicative of the selection of “ACCEPT” icon 374A to executed mobile banking application 108, which may perform operations (not illustrated in FIG. 3B), that access element 334 of targeted incentive data 332 associated with the targeted, merchant-specific offer, and that obtain the URL associated with the merchant-specific offer, e.g., the purchase of the discounted tickets to the Orlando-area theme parks. In some instances, not illustrated in FIG. 3B, executed mobile banking application 108 may perform operations that trigger programmatically one or more additional application programs maintained within memory 105, such as the web browser described herein, and that provision the obtained URL to the executed web browser, which may cause display unit 109A to present portions of the web page that facilitates the purchase of the discounted tickets to the Orlando-area theme parks (e.g., in accordance with the targeted, merchant-specific offer) within a digital interface.

Alternatively, upon viewing graphical representation 374, user 101 may decline the targeted, merchant-specific offer for the discounted tickets to the Orlando-area theme parks, and may provide additional input provided to input unit 109B of client device 102 that selects “DECLINE” icon 374B presented within notification interface 368 (not illustrated in FIG. 3B). Based on the decision by user 101 to decline the targeted, merchant-specific offer for the discounted tickets to the Orlando-area theme parks, and responsive to the provisioned additional input selecting “DECLINE” icon 374B, executed extraction module 362 may also perform operations, described in reference to FIG. 3C, that parse additional, or alternate, ones of incentive notification 358, such as customer-specific incentive notification 358B associated with the targeted, customer-specific offer to provision the unsecured, personal loan to user 101 in accordance with the determined terms and conditions, and that obtain, from customer-specific incentive notification 358B, the portion of available incentive data 336 that identifies the unsecured, personal loan available to user 101, term data 340 that identifies one or more terms and condition of the unsecured, personal loan, and the elements of digital content 342.

By way of example, and as described herein, the terms and condition of the unsecured, personal loan, and maintained within term data 340, may include, but are not limited to, the loan amount (e.g., the $905.00 purchase price of the three, economy-class airline tickets), the interest rate for the personal loan (e.g., 1.3% APR), a term of the unsecured personal loan (e.g., twelve months), and the minimum monthly payment across the term of the loan. Referring to FIG. 3C, executed extraction module 362 may provide the extracted the portion of available incentive data 336, term data 340, and the elements of digital content 342 as inputs to executed interface element generation module 364, which may perform operations that generate additional interface elements 376 based on portions of available incentive data 336, term data 340, and the elements of digital content 342, and that route interface elements 376 to display unit 109A.

When rendered for presentation within a corresponding notification interface 368 by display unit 109A, interface elements 376 provide a graphical representation 378 of the targeted, customer-specific offer to provision the unsecured, personal loan available to user 101 in accordance with the determined terms and conditions within a single display screen or window, or across multiple display screens or windows, of notification interface 368. For example, when presented within notification interface 368, graphical representation 378 may identify the available, unsecured personal loan and present the targeted, customer-specific offer in real-time and contemporaneously with the presentation of graphical representation 370, and prompt user 101 to accept the offer to fund at least a portion of the requested, real-time payment of $905.00 associated with user 101 purchase of the three, economy-class airline tickets from merchant 111, e.g., based on input provided to input unit 109B of client device 102 that selects a respective one of an “ACCEPT” icon 378A and a “DECLINE” icon 378B presented within notification interface 368.

By way of example, and upon viewing graphical representation 378, user 101 may elect to accepted the offered provisioning of the available, unsecured personal loan, which may fund the requested, real-time payment of $905.00, and user 101 may provide input to client device 102 (e.g., via input unit 109B) that selects “ACCEPT” icon 378A presented within notification interface 368. Based on the selection of icon 374A, input unit 109B may route corresponding elements of input data indicative of the selection of “ACCEPT” icon 378A to executed mobile banking application 108, which may perform operations (not illustrated in FIG. 3C) that generate a response to customer-specific incentive notification 358B that includes an incentive confirmation of the acceptance of the targeted, customer-specific offer in accordance with the determined terms or conditions, and that cause FI computing system 130 to transmit the generated response across network 120 to FI computing system 130. Although not illustrated in FIG. 3C, a programmatic interface established and maintained by FI computing system 130, such as API 302, may receive the response, and may route the response to incentive determination module 324 of executed analytical engine 148, which may parse the response and confirm the acceptance of the targeted, customer-specific offer (e.g., the provisioning of the unsecured personal loan in accordance with the determined terms or conditions). Based on the confirmation of the acceptance of the targeted, customer-specific offer by user 101, executed incentive determination module 324 may perform any of the exemplary processes described herein to complete a qualification or underwriting process (e.g., in accordance with elements of qualification data 338) and provision the unsecured personal loan to user 101 in accordance with the determined terms and conditions (e.g., the $905.00 loan amount, the 1.3% APR, the twelve-month term, etc.).

Further, although not illustrated in FIG. 3C, executed incentive determination module 324 may also perform operations that generate elements of product data that identify the provisioned, unsecured personal loan (e.g., a corresponding account number) and the specify the terms and conditions (e.g., the $905.00 loan amount, the 1.3% APR, the twelve-month term, etc.), and that store the generated elements of product data within a corresponding portion of account data 140C associated with user 101. In some instances, also not illustrated in FIG. 3C, RTP engine 152 may, upon execution of by the one or more processors of FI computing system 130, access the product data associated with the unsecured personal loan, and perform any of the exemplary processes described herein to generate a response to RFP message 226 that confirms the funding of the requested $905.00 payment using the unsecured loan product, to transmit the response across network 120 to merchant computing system 110, either directly or through one or more intermediate computing systems associated with a clearinghouse or with a financial institution of the merchant, and executed RTP engine 152 may also perform operations that access RFP message 226 maintained within RFP queue 135, and delete RFP message 226 from RFP queue 135.

In other instances, upon viewing graphical representation 378, user 101 may decline the targeted, customer-specific offer to fund the $905.00 purchase price of the three, economy-class airline tickets using an unsecured personal loan available to user 101, and may provide additional input provided to input unit 109B of client device 102 that selects “DECLINE” icon 378B presented within notification interface 368 (not illustrated in FIG. 3B). Based on the decision by user 101 to decline the targeted, customer-specific offer, and responsive to the provisioned additional input selecting “DECLINE” icon 378B, executed extraction module 362 may also perform operations, described in reference to FIG. 3D, that parse additional, or alternate, ones of incentive notification 358, such as loyalty-specific incentive notification 358C associated with the targeted, loyalty-specific offer to offset all, or a customer-selected portion of, the $905.00 cost of the purchased airlines tickets using accrued loyalty points, and that obtain, from customer-specific incentive notification 358B the portion of available incentive data 346 (e.g., that includes a URL to the web page that enables user 101 to offset all, or a customer-selected portion of, the $905.00 cost of the purchased airlines tickets using the accrued loyalty points), status data 348 that identifies the 35,000 available loyalty points, and the elements of digital content 350. Referring to FIG. 3C, executed extraction module 362 may provide the obtained portion of available incentive data 346, status data 348, and the elements of digital content 350 to executed interface element generation module 364, which may perform operations that generate additional interface elements 380 based on portions of available incentive data 346, status data 348, and digital content 350, and that route interface elements 380 to display unit 109A.

When rendered for presentation within a corresponding notification interface 368 by display unit 109A, interface elements 380 provide a graphical representation 382 of the targeted, loyalty-specific offer to offset all, or a customer-selected portion of, the $905.00 cost of the purchased airlines tickets using accrued loyalty points within a single display screen or window, or across multiple display screens or windows, of notification interface 368. For example, when presented within notification interface 368, graphical representation 382 may identify the total number of loyalty points available to offset the $905.00 payment (e.g., 35,000 loyalty points) and present the targeted, loyalty-specific offer in real-time and contemporaneously with the presentation of graphical representation 370, and may prompt user 101 to accept the airlines tickets using accrued loyalty points, e.g., based on input provided to input unit 109B of client device 102 that selects a respective one of an “ACCEPT” icon 382A and a “DECLINE” icon 382B presented within notification interface 368.

For example, upon viewing graphical representation 382, user 101 may elect to accepted the targeted, loyalty-specific offer to offset all, or a customer-selected portion of, the $905.00 cost of the purchased airlines tickets using accrued loyalty points, and user 101 may provide input to client device 102 (e.g., via input unit 109B) that selects “ACCEPT” icon 382A presented within notification interface 368. Based on the selection of icon 382A, input unit 109B may route corresponding elements of input data indicative of the selection of “ACCEPT” icon 382A to executed mobile banking application 108, which may perform operations (not illustrated in FIG. 35), that access element 352 of targeted incentive data 332 associated with the targeted, loyalty-specific offer, and that obtain the URL of the web page that enables user 101 to offset all, or a customer-selected portion of, the $905.00 cost of the purchased airlines tickets using the accrued loyalty points. In some instances, not illustrated in FIG. 3D, executed mobile banking application 108 may perform operations that trigger programmatically one or more additional application programs maintained within memory 105, such as the web browser described herein, and that provision the obtained URL to the executed web browser, which may cause display unit 109A to present portions of the web page that enables user 101 to offset all, or a customer-selected portion of, the $905.00 cost of the purchased airlines tickets using the accrued loyalty within a digital interface.

By way of example, and based on the presented portions of the web page, user 101 may elect to offset the entire, $905.00 purchase price of the three, economy-class airline tickets using 32,500 of the available, and accrued, loyalty points. User 101 may, for instance, provide input to client device 102 (e.g., via input unit 109B) that specifies the intention to offset the $905.00 purchase price with 32,500 of the available loyalty points, and based on the provisioned input, executed mobile banking application 108 may perform operations (not illustrated in FIG. 3D) that generate a response to loyalty-specific incentive notification 358C that confirms the acceptance of the targeted, loyalty-specific offer and specifies the intention to offset the $905.00 purchase price with 32,500 of the available loyalty points, and that cause client device 102 to transmit the generated response across network 120 to FI computing system 130. Although not illustrated in FIG. 3D, a programmatic interface established and maintained by FI computing system 130, such as API 302, may receive the response, and may route the response to incentive determination module 324 of executed analytical engine 148, which may parse the response, and confirm the acceptance of the targeted, loyalty-specific offer and the specified intention of user 101 to offset the $905.00 purchase price with 32,500 of the available loyalty points.

In some instances, executed incentive determination module 324 may perform operations (not illustrated in FIG. 3D) that generate data debiting the 32,500 points from the 35,000 points available to user 101, and that store the generated data within a portion of loyalty data 140B associated with user 101. Executed incentive determination module 324 may also route the generated data to executed RTP engine 152, which may perform any of the exemplary processes described herein to generate a response to RFP message 226 that confirms the funding of the requested $905.00 payment using the 32,500 loyalty points, and to transmit the response across network 120 to merchant computing system 110, either directly or through one or more intermediate computing systems associated with a clearinghouse or with a financial institution of the merchant. Executed RTP engine 152 may also perform operations that access RFP message 226 maintained within RFP queue 135, and delete RFP message 226 from RFP queue 135.

The disclosed embodiments are, however, not limited to processes that generate, and render for presentation within notification interface 368, graphical representations of the exemplary merchant-, customer-, and/or loyalty-specific incentive notifications described herein, which that characterize corresponding exemplary merchant-, customer-, and/or loyalty-based offers or incentives associated with the initiated purchase transaction and consistent with the determined customer intent of the initiated purchase transaction. In other instances, executed notification engine 150 may perform any of the exemplary processes described herein to generate further ones of incentive notifications 358, which identify, and characterize, additional or alternate merchant-, customer-, and/or loyalty-based offers or incentives that are associated with user 101 and with the initiated purchased transaction and the determined customer intent of that initiated purchase transaction, e.g., the purchase of the economy-class airline tickets in support of the family vacation to Orlando, Fla. during the winter break.

Further, in some examples, FI computing system 130 may perform any of the exemplary processes described herein to generate and provision to client device 102, in real-time and contemporaneously with an initiation of a purchase transaction associated with an ISO-20022 compliant RFP message, a payment notification characterizing a requested, real-time payment associated with the ISO-20022 compliant RFP message and one or more incentive notifications identifying, and characterizing corresponding, targeted merchant-, customer-, or loyalty-specific offers or incentives consistent with a determined customer intent of the initiated purchase transaction. Client device 102 may, in some instances, to perform any of the exemplary processes described herein to process the received payment notification and each, or a selected subset, of the incentive notifications, and present a graphical representation of the processed payment notification and a graphical representation of one or more of the processed incentive notifications within corresponding portions of a single display screen, or across multiple display screens, of a notification interface, such as notification interface 368 of FIGS. 3B, 3C, and 3D. As described herein, the presented graphical representations of the payment and incentive notifications may facilitate a provisioning of input, by user 101, to input unit 109B of client device 102 that approves, or rejects the requested, real-time payment and further, that accepts, or declines, one or more of the targeted merchant-, customer-, or loyalty-specific offers or incentives consistent with a determined customer intent.

In other instances, described herein, FI computing system 130 may perform any of the exemplary processes described herein to further process the elements of decomposed message data characterizing user 101, merchant 111, and the initiated purchase transaction to generate elements of behavioral data that characterize a current, or time-evolving, transactional behavior of user 101. The behavioral data may, for example, characterize a pattern of prior purchase transactions that involve particular counterparties (e.g., retailers or merchants, etc.), that involve particular products or services, or that are associated with particular geographic locations or regions, and FI computing system 130 may perform operations that transmit the generated elements of behavioral data, and additionally or alternatively, one or more elements of the intent data, across network 120 to computing systems associated with a predetermined set of merchants or retailers (e.g., having a relationship with the financial institution, etc.). In some instances, one or more of the computing systems associated with the predetermined set of merchants or retailers, may perform any of the exemplary processes described herein to process the elements of behavioral data and/or the intent data and provision, to client device 102, a notification that includes elements of digital content characterizing one or more additional, or alternate targeted offers or incentives associated with user 101, a corresponding one or more merchants or retailers (e.g., merchant 111), and the initiated purchase transaction, e.g., in real-time and contemporaneously with the initiated purchase transaction.

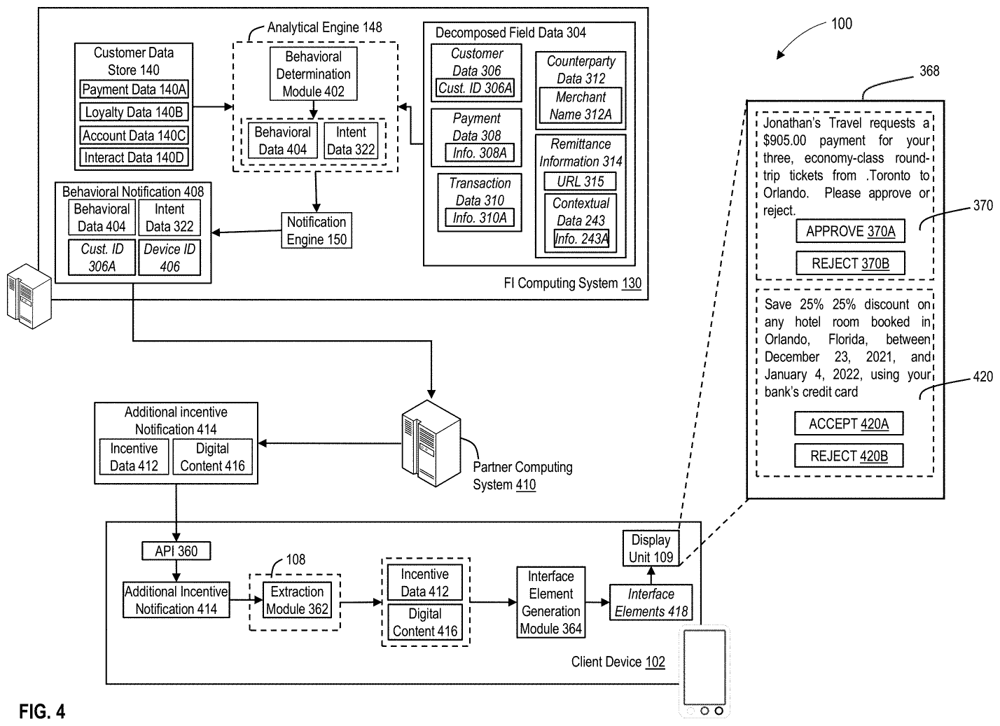

Referring to FIG. 4, behavioral determination module 402 of executed analytical engine 148 may access data repository 134 and obtain decomposed field data 304, which includes the elements of customer data 306, payment data 308, transaction data 310, or counterparty data 312 extracted from RFP message 226 or formatted invoice data 240. In some instances, executed intent determination module 320 may access customer data 306, and obtain a unique customer identifier 306A of user 101, such as, but not limited to, a customer name (e.g., “John Q. Stone”) or an alphanumeric login credential associated with user 101. Further, executed intent determination module 320 may access payment data 308, transaction data 310, and counterparty data 312, and obtain corresponding ones of payment information 308A that includes, among other things, the $905.00 payment amount and the requested payment date of Dec. 1, 2021, information 310A that, includes, among other things, a quantity of the purchased airline tickets and a unique identifier of the purchase airline tickets (e.g., a UPC assigned to the airline tickets, etc.), and a merchant name 312A of merchant 111 (e.g., merchant name “Jonathan's Travel). Further, executed intent determination module 320 may access contextual data 243, and obtain information 243A that includes, among other things, the departure and return dates (e.g., Dec. 13, 2021, and Jan. 4, 2022, respectively), the destination city or airport (e.g., Orlando, Fla.), flight times and flights number for the departure and return flights, seat numbers for the purchased, economy-class tickets, or an identifier of one or more airlines associated with the purchased economy-class tickets (e.g., an airline name, etc.). Further, and based on customer identifier 306A, executed behavioral determination module 402 may also perform operations that access customer data store 140, and obtain elements of transaction data 140A, account data 140C, and customer profile data 140D associated with user 101.

Based on payment information 308A, transaction information 310A, contextual information 243A, and on the obtained elements of transaction data 140A, account data 140C, and customer profile data 140D associated with user 101, executed behavioral determination module 402 may perform operations that generate one or more elements of behavioral data 404 that characterize a current, or time-evolving, transactional behavior of user 101. The elements of behavioral data 404 may, for example, characterize a pattern of prior purchase transactions that involve particular counterparties (e.g., retailers or merchants, such as merchant 111, etc.), that involve particular products or services, or that are associated with particular geographic locations or regions. In some examples, executed behavioral determination module 402 may also access elements of intend data 322, which identify and characterize a customer intent associated with the initiated purchase transaction, e.g., the $905.00 purchase of the three, economy-class airline tickets, and the requested, real-time payment characterized by the elements of decomposed field data 304. Executed behavioral determination module 402 may route the elements of behavioral data 404 and intent data 322 to executed notification engine 150, which may perform operations that package customer identifier 306A, a device identifier 406 of client device 102 (e.g., an IP or MAC address, etc., maintained within the elements of customer profile data 140D associated with user 101), and the elements of behavioral data 404 and intent data 322 into corresponding portions of a behavioral notification 408, which FI computing system 130 may broadcast across network 120 to computing systems associated with a predetermined set of merchants or retailers, e.g., those merchants or retailers having a relationship with the financial institution.

For example, as illustrated in FIG. 4, FI computing system 130 may transmit behavioral notification 408 across network 120 a partner computing system 410 associated with a corresponding merchant, such as a hotel chain, associated with and having a relationship with the financial institution. Partner computing system 410 may represent a computing system that includes one or more servers and one or more tangible, non-transitory memory devices storing executable code, application engines, or application modules. Each of the one or more servers may include one or more processors, which may be configured to execute portions of the stored code, application engines, or application modules to perform operations consistent with the disclosed exemplary embodiments. Further, partner computing system 410 may also include one or more communications units, devices, or interfaces, such as one or more wireless transceivers, coupled to the one or more processors for accommodating wired or wireless internet communication across network 120 with other computing systems and devices operating within environment 100. In some instances, partner computing system 410 may correspond to a discrete computing system, although in other instances, partner computing system 410 may correspond to a distributed computing system having multiple, computing components distributed across an appropriate computing network, such as communications network 120 of FIG. 1A, or those established and maintained by one or more cloud-based providers, such as Microsoft Azure™, Amazon Web Services™, or another third-party, cloud-services provider.

Referring back to FIG. 4, partner computing system 410 may perform operations that process the elements of intent data 322 to determine the customer intent associated with the initiated purchase transaction, e.g., the $905.00 purchase of the three, economy-class airline tickets in support of a family vacation to Orlando, Fla. during a winter break. Further, and based on the determined customer intent, and on the elements of behavioral data 404, which characterize a current, or time-evolving, transactional behavior of user 101, partner computing system 410 may perform operations that generate, or obtain, additional elements of incentive data 412, which characterize an additional, merchant-specific incentive that is available to user 101 and consistent with the determined customer intent of the initiated purchase transaction. By way of example, the additional, merchant-specific incentive nay include a predetermined, 25% discount on any hotel room booked in Orlando, Fla., between Dec. 13, 2021, and Jan. 4, 2022 using a credit-card account issued by the financial institution, and partner computing system 410 may perform operations that generate an additional incentive notification 414 that includes all, or a selected portion, of incentive data 412 and elements of digital content or layout data 416 associated with the additional, merchant-specific incentive. As illustrated in FIG. 4, partner computing system 410 may transmit additional incentive notification 414 across network 120 to client device 102, e.g., based on the IP address or other network address maintained within device identifier 406.

A programmatic interface established and maintained by client device 102, such as application programming interface (API) 360 associated with mobile banking application 108, may receive incentive notification 414, and may route incentive notification 414 to executed extraction module 362. As described herein, executed extraction module 362 may receive incentive notification 414, which includes incentive data 412 and digital content or layout data 416, and may perform operations that parse incentive notification 414 and that obtain incentive data 412 and digital content or layout data 416. By way of example, incentive data 412 may include a URL associated with the additional, merchant-specific offer, e.g., the predetermined, 25% discount on any hotel room booked in Orlando, Fla., between Dec. 13, 2021, and Jan. 4, 2022 using the credit-card account issued by the financial institution. Executed extraction module 362 may provide incentive data 412 and digital content or layout data 416 as input to executed interface element generation module 364, which may perform operations that generate additional elements 418 based on portions of incentive data 412 and digital content or layout data 416, and that route interface elements 418 to display unit 109A.

When rendered for presentation within a corresponding notification interface 3 by display unit 109A, interface elements 418 provide a graphical representation 420 of the additional, merchant-specific offer, e.g., the predetermined, 25% discount on any hotel room booked in Orlando, Fla., between Dec. 13, 2021, and Jan. 4, 2022, using a credit-card account issued by the financial institution, within a single display screen or window, or across multiple display screens or windows, of notification interface 368. For example, interface elements 366 may, when presented within notification interface 368, graphical representation 374 may identify the predetermined 25% discount and present the additional, merchant-specific offer in real-time and contemporaneously with the presentation of graphical representation 370, and prompt user 101 to initiate a spur-of-the-moment purchase related to determined customer intent in real-time and contemporaneously with the approval or rejection of the requested, real-time payment of $905.00 to merchant 111, e.g., based on input provided to input unit 109B of client device 102 that selects a respective one of an “ACCEPT” icon 420A and a “DECLINE” icon 420B presented within notification interface 368.

For example, upon viewing graphical representation 420, user 101 may elect to reserve a hotel room in Orlando, Fla., between Dec. 13, 2021, and Jan. 4, 2022, in accordance with the additional, merchant-specific offer, and user 101 may provide input to client device 102 (e.g., via input unit 109B) that selects “ACCEPT” icon 420A presented within notification interface 368. Based on the selection of icon 420A, input unit 109B may route corresponding elements of input data indicative of the selection of “ACCEPT” icon 420A to executed mobile banking application 108, which may perform operations (not illustrated in FIG. 3B), that access incentive data 412 associated with the additional, merchant-specific offer, and that obtain the URL associated with the additional, merchant-specific offer, e.g., the reservation of the hotel room in Orlando, Fla., between Dec. 13, 2021, and Jan. 4, 2022. In some instances, not illustrated in FIG. 3B, executed mobile banking application 108 may perform operations that trigger programmatically one or more additional application programs maintained within memory 105, such as the web browser described herein, and that provision the obtained URL to the executed web browser, which may cause display unit 109A to present portions of the web page that facilitates the reserve a hotel room in Orlando, Fla., between Dec. 13, 2021, and Jan. 4, 2022 (e.g., in accordance with the additional, merchant-specific offer) within a digital interface.

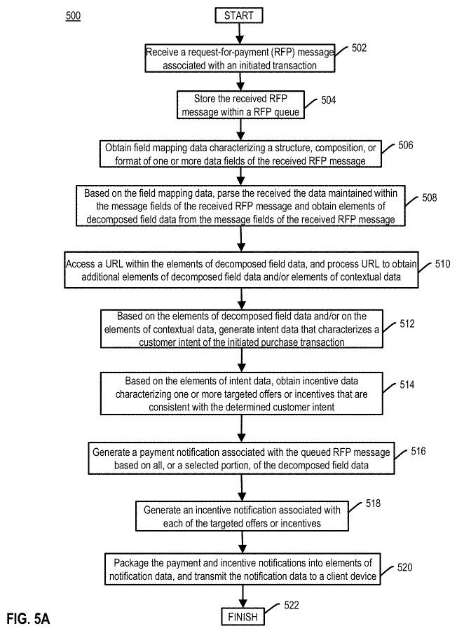

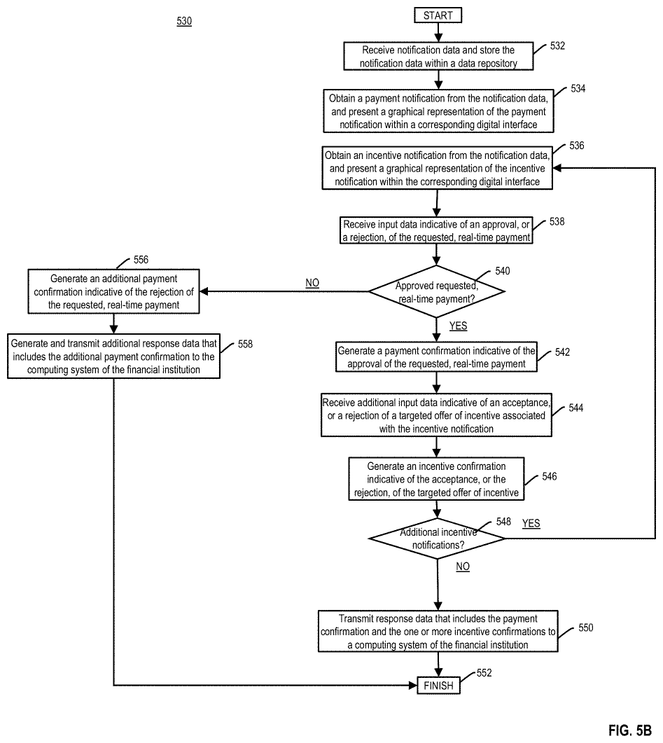

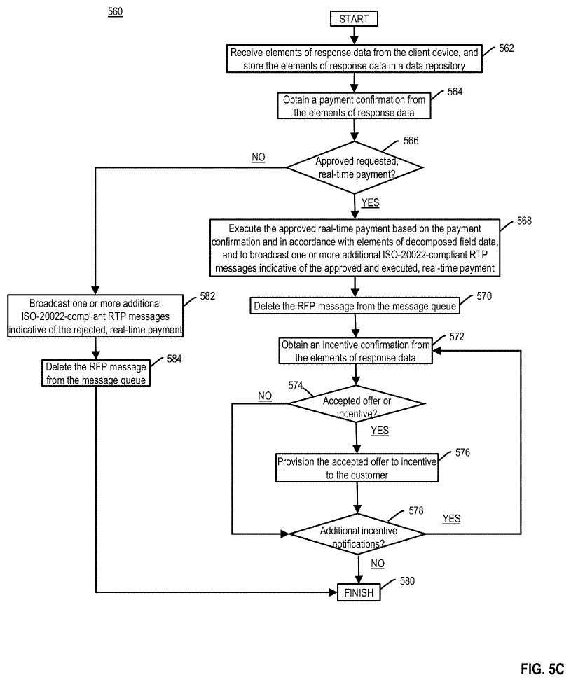

FIGS. 5A, 5B, and 5C are flowcharts of exemplary processes for provisioning targeted digital content associated with an initiated exchange of data in real-time, and contemporaneously with the initiation of the data exchange, based on a request-for-payment (RFP) message formatted and structured in accordance with one or more standardized data-exchange protocols. For example, one or more computing systems associated with a financial institution, such as FI computing system 130, may perform one or more of the steps of exemplary process 600, as described below in reference to FIG. 6A, and one or more of the steps of exemplary process 660, as described below in reference to FIG. 5C. Further, a computing device associated with, or operable by, user 101, such as client device 102, may perform one or more of the steps of exemplary process 630, as described below in reference to FIG. 5B.

Referring to FIG. 5A, FI computing system 130 may perform any of the processes described herein to obtain a RFP message associated with the initiated exchange of data (e.g., in step 502). As described herein, the data exchange may include, but is not limited to, a purchase transaction initiated between a first counterparty (e.g., a merchant, such as merchant 111 associated with merchant computing system 110) and a second counterparty (e.g., a customer of the merchant, such as user 101 associated with client device 102), and the purchase transaction may involve, or be associated with one or more products or services provisioned by the first counterparty to the second counterparty (e.g., the purchased, economy-class airline tickets to travel from Toronto, Canada, to Orlando, Fla., etc.).

The RFP message may be generated by merchant computing system 110 using any of the exemplary processes described herein, and in some instances, FI computing system 130 may receive the RFP message directly from merchant computing system 110 across a corresponding communications network (e.g., network 120), or may receive the RFP message from via one or more intermediate computing systems, such as, but not limited to, as a computing system associated with the financial institution of merchant 111 or one or more computing systems of a clearinghouse associated with the RTP ecosystem. In other instances, the RFP message may be generated by one of intermediate computing systems, such as the computing system associated with the financial institution of merchant 111 or the one or more computing systems of the clearinghouse, based on elements of data characterizing the purchase transaction and generated by merchant computing system 110.

As described herein, the received RFP message may include message fields consistent with the ISO 20022 standard for electronic data exchange between financial institutions, and each of the message fields may be populated with data structured and formatted in accordance with the ISO 20022 standard. By way of example, the received, ISO-20022-compliant RFP message may include, among other things: (i) message fields populated with data specifying a full name and postal address of user 101; (ii) message fields populated with data identifying a payment instrument selected by user 101 to fund the initiated purchase transaction; (iii) message fields populated with data specifying a name and postal address of merchant 111; (iv) message fields populated with data identifying a financial services account held by merchant 111 and available to receive processed from the requested payment; and (v) message fields populated with one or more parameter values that characterize the purchase transaction, a requested payment method, and/or a requested payment date. Further, and as described herein, the received, ISO-20022-compliant RFP message may also include structured or unstructured message fields that specify additional remittance information associated with the purchase transaction, and examples of the additional remittance information include, but are not limited to, information identifying a product or service involved in the purchase transaction, or a link to remittance data associated with the initiated transaction (e.g., a long-form URL or shortened to a PDF or HTML invoice, as described herein).

Referring back to FIG. 6A, FI computing system 130 may store the received RFP message within a corresponding portion of locally accessible data repository, such as within RFP message queue 135 of data repository 134 (e.g., in step 504 of FIG. 6A), and may obtain, from the locally accessible data repository, one or more elements of field mapping data that characterize a structure, composition, or format of one or more data fields of the received RFP message (e.g., in step 506 of FIG. 5A). Based on the obtained elements of the field mapping data, FI computing system 130 may perform any of the exemplary processes described herein to parse the data maintained within the message fields of the received RFP message, and to obtain elements of decomposed field data that identify and characterize user 101, merchant 111, the purchase transaction, and the payment requested from user 101 by merchant 111 for the purchased products or services (e.g., in step 508 of FIG. 5A). For example, the elements of decomposed field data (e.g., decomposed field data 304 of FIG. 3A) may include, but are not limited to, customer data that identifies a full name or address of user 101 (e.g., customer data 306 of decomposed field data 304), payment data that identifies a requested payment date, a requested payment account, a payment instrument selected by user 101 to fund the purchase transaction, or a (e.g., payment data 308 of decomposed field data 304), transaction data that includes a value of one or more parameters of the transaction, such as a total transaction amount, a transaction subtotal or an imposed local tax, or an identifier of one or more of the purchased products or services (e.g., transaction data 310 of decomposed field data 304), and counterparty data that includes a name of merchant 111, or a postal address associated with merchant 111 (e.g., counterparty data 312 of decomposed field data 304). FI computing system 130 may also perform operations, described herein, that store the elements of decomposed field data in a data repository (e.g., also in step 508).

Further, and as described herein, the elements of decomposed field data may also include additional elements of structured or unstructured remittance data, such as, but not limited to, a long-form URL or a shortened URL that point to elements of formatted receipt data (e.g., in PDF or HTML form) associated with the initiated purchase transaction and maintained at one or more additional computing systems, such as merchant computing system 110 (e.g., URL 315 of remittance information 314 of decomposed field data 304). In some instances, FI computing system 130 may perform any of the exemplary processes described herein to process the long-form URL or a shortened URL and to obtain (i) additional elements of decomposed field data that identify and characterize user 101, merchant 111, the initiated purchase transaction, and the payment requested from user 101 by merchant 111 for the purchased products or services, and/or (ii) elements of contextual data (e.g., contextual data 243 of remittance information 314) that further characterize user 101, merchant 111, the initiated purchase transaction, or the payment requested (e.g., in step 510 of FIG. 5A). FI computing system 130 may also perform operations, described herein, that store the additional elements of decomposed field data and/or the elements of contextual data within the data repository (e.g., also in step 510).

For example, the long-form URL may include one or more embedded elements of customer data, counterparty data, or transaction data, such as, but not limited to, the postal code of the merchant 111 involved in the initiated purchase transaction and an identifier of the customer. In some instances, FI computing system 130 may perform any of the exemplary processes described herein may parse the long URL to identify and extract one or more of the additional elements of decomposed field data from the long-form URL, and to store the additional elements of decomposed field within the data repository (e.g., in step 510 of FIG. 5A). Further, in some examples, FI computing system 130 may perform any of the exemplary processes described herein to process the long- or shortened URL and obtain elements of formatted data associated with the initiated purchase transaction and maintained by a computing system of the merchant, such as formatted invoice data 240 of FIG. 2A (e.g., also in step 510 of FIG. 5A).

As described herein, the formatted data may be structured in PDF or HTML format, and FI computing system 130 may perform any of the exemplary processes described herein to may perform operations, described herein to process the elements of formatted data (e.g., through an application of an optical character recognition (OCR) process to the formatted data structured in PDF form, or to parse code associated with, or apply a screen-scraping process to, the formatted data structured in HTML form), and obtain one or more of the additional elements of the decomposed field data and/or the elements of contextual data (e.g., also in step 510 of FIG. 5). In some instances, and for the initiated purchase transaction involving the three, economy-class airline tickets departing from Toronto, Canada, to Orlando, Fla., on Dec. 13, 2021, and returning from Orlando, Fla., on Jan. 4, 2022, the element of contextual data may include, but are not limited to, the departure and return dates (e.g., Dec. 13, 2021, and Jan. 4, 2022, respectively), the destination city or airport (e.g., Orlando, Fla.), flight times and flights number for the departure and return flights, seat numbers for the purchased, economy-class tickets, or an identifier of one or more airlines associated with the purchased economy-class tickets (e.g., an airline name, etc.).

Based on the elements of decomposed field data, and in some instances, on the elements of contextual data, FI computing system 130 may perform any of the exemplary processes described herein to generate elements of intent data that characterize a customer intent associated with the initiated purchase transaction, and based on determined customer intent (e.g., in step 512 of FIG. 5A), to obtain incentive data characterizing one or more targeted offers or incentives that are associated with user 101 and the initiated purchase transaction, and that are consistent with the determined customer intent of the initiated purchase transaction (e.g., in step 514 of FIG. 5A). As described herein, examples of these targeted offers or incentives may include, but are not limited to, or more merchant-, customer-, and/or loyalty-based offers or incentives associated with user 101 or the initiated purchase transaction, including an offer to provision, to user 101, a financial product capable of financing all or a portion of the initiated purchase transaction (e.g., an unsecured personal loan, an installment loan, etc.).

FI computing system 130 may perform any of the exemplary processes described herein to generate one or more elements of a payment notification associated with the queued RFP message based on all, or a selected portion, of the decomposed field data (e.g., in step 516 of FIG. 5A). By way of example, and as described herein, the payment notification may be associated with the requested payment, and that payment notification may include, among other things, the full name of user 101, the requested payment date, information identifying the selected payment instrument, information identifying merchant 111, information identifying the products or services associated with, or involved in, the purchase transaction. Further, in some examples, the payment notification may also include digital content that, when presented on a digital interface generated by an application program executed at client device 102 (e.g., mobile banking application 108 of FIG. 1, etc.), prompt user 101 to provide input to client device 102 that approves, or alternatively, declines, the real-time payment requested from user 101 by merchant 111.

Further, and as illustrated in FIG. 6A, FI computing system 130 may also perform any of the exemplary processes described herein to generate one or more elements of an incentive notification associated with each of the targeted offers or incentives (e.g., in step 518 of FIG. 5A). By way of example, for a particular one of the targeted offers or incentives, the corresponding incentive notification may include, but is not limited to, information that identifies and characterizes the particular targeted offer or incentive (e.g., corresponding elements of incentive data, etc.) and digital content that, when presented on a digital interface generated by an application program executed at client device 102 (e.g., mobile banking application 108 of FIG. 1, etc.), prompt user 101 to provide input to client device 102 that accepts, or alternatively, declines, the particular targeted offer or incentive in real-time and contemporaneously within the initiation of the purchase transaction.

FI computing system 130 may also perform any of the exemplary processes described herein to package the generated payment notification and the one or more incentive notification into corresponding portions of notification data, and to transmit the elements of notification data across network 120 to client device 102 (e.g., in step 520 of FIG. 5A). In some instances, client device 102 may receive the elements of notification data, and an application program executed by the one or more processors of client device 102 (e.g., executed mobile banking application 108) may perform any of the exemplary processes described herein to present, within a corresponding digital interface, a graphical representation of the payment notification that prompts user 101 to approve, or reject, the real-time payment requested by merchant 111, and based on input indicative of the approval or rejection of the requested, real-time payment by user 101, to present, within the corresponding digital interface, a graphical representation of one or more of the targeted offers or incentives that are consistent with the customer intent of the initiated purchase transaction. Exemplary process 600 is then complete in step 522 of FIG. 5A.

Referring to FIG. 5B, client device 102 may perform any of the exemplary processes described herein to receive the elements of notification data from FI computing system 130, and store the elements of notification data within a portion of a tangible, non-transitory memory accessible to client device 102 (e.g., in step 532 of FIG. 5B). Client device 102 may also perform any of the exemplary processes described herein to obtain the payment notification from the received elements of notification data, and generate, and render for presentation within a corresponding digital interface, a graphical representation of the payment notification that prompts user 101 to approve, or alternatively, reject, the real-time payment requested from user 101 by merchant 111 (e.g., in step 534 of FIG. 5B). Client device 102 may also perform any of the exemplary processes described herein to obtain one of the incentive notification from the received elements of notification data, and generate, and render for presentation within a corresponding digital interface, a graphical representation of the obtained incentive notification that prompts user 101 to accept, or alternatively, reject, the corresponding one of the targeted offers or incentives (e.g., in step 536 of FIG. 5B).

Further, client device 102 may also receive, via input unit 109B, elements of user input indicative of an approval, or alternatively, a rejection, of the requested, real-time payment by user 101 (e.g., in step 538 of FIG. 5B), and based on the elements of user input, client device 102 may determine whether user 101 approved, or rejected, the requested real-time payment (e.g., in step 540 of FIG. 5B). If, for example, client device 102 were to determine that user 101 approved the requested, real-time payment (e.g., step 540; YES), client device 102 may perform any of the exemplary processes described herein to process the elements of input data and generate a payment confirmation indicative of the approval, by user 101, of the requested real-time payment (e.g., in step 542 of FIG. 5B). Client device 102 may also receive, via input unit 109B, additional elements of user input indicative of an acceptance, or a rejection, of the corresponding one of the targeted offers or incentives (e.g., in step 544 of FIG. 5B), and client device 102 may perform any of the exemplary processes described herein to process the additional elements of input data and generate an incentive confirmation indicative of the acceptance, or rejection, of the corresponding one of the targeted offers or incentives (e.g., in step 546 of FIG. 5B).

Client device 102 may also perform operations that parse the received notification data and determine whether the notification data includes additional incentive notifications awaiting presentation (e.g., in step 548 of FIG. 5B). If, for example, client device 102 were to determine that the notification data includes additional incentive notifications awaiting processing (e.g., step 548; YES), exemplary process 500 may pass back to step 536, and client device 102 may perform any of the exemplary processes described herein to obtain an additional one of the incentive notification from the received elements of notification data, and generate, and render for presentation within the corresponding digital interface, a graphical representation of the obtained additional incentive notification.

Alternatively, if client device 102 were to determine that the notification data no further incentive notifications (e.g., step 548; NO), client device 102 may also perform any of the exemplary processes described herein to generate elements of response data that include the payment and incentive confirmations, and to transmit the elements of response data across network 120 to FI computing system 130 (e.g., in step 550 of FIG. 5B). Exemplary process 530 is then complete in step 552.

Further, and referring back to step 540, if client device 102 were to determine that user 101 rejected the requested, real-time payment (e.g., step 540; NO), client device 102 may perform any of the exemplary processes described herein to generate an additional payment confirmation indicating the rejection of the requested, real-time payment by user 101 (e.g., in step 556 of FIG. 5B), and to generate elements of additional response data that include the additional payment confirmation in conjunction with the identifier of user 101 and/or merchant 111 (e.g., in step 558 of FIG. 5B). Client device 102 may also transmit the elements of additional response data across network 120 to FI computing system 130 (e.g., also in step 558 of FIG. 5B). Exemplary process 530 is then complete in step 552.

Referring to FIG. 5C, FI computing system 130 may receive the elements of response data from client device 102, and may store the received elements of response data within one or more tangible, non-transitory memories accessible to FI computing system 130, such as in conjunction with the elements of decomposed field data within data repository 134 (e.g., in step 562 of FIG. 5C). FI computing system 130 may also perform any of the exemplary processes described herein to obtain, from the elements of response data, the payment confirmation indicative of the approval, or alternatively, the rejection, of the real-time payment request from user 101 by merchant 111 (e.g., in step 564 of FIG. 5C), and to process the payment confirmation and to determine whether user 101 approved, or rejected, the real-time payment (e.g., in step 566 of FIG. 5C).

If, for example, FI computing system 130 were to determine that user 101 approved the requested, real-time payment (e.g., step 566; YES), FI computing system 130 may perform any of the exemplary processes described herein to execute the now-approved real-time payment based on the payment confirmation and in accordance with the elements of decomposed field data (e.g., in step 568 of FIG. 5C). By way of example, in step 568, FI computing system 130 may perform any of the exemplary processes described herein to obtain the identifier of user 101 from the elements of response data, to access the elements of decomposed field data, and based on the identifier of user 101, to obtain account data that identifies the payment instrument held by user 101 and capable of funding the real-time payment and a payment amount of the real-time payment. FI computing system 130 may also perform operations in step 568 that, in real-time, debit the payment amount from the account associated with the payment instrument, and transmit one or more additional ISO-20022-compliant RTP messages that confirm the approval of the requested, real-time payment by user 101 and the real-time debiting of the payment amount from the account associated with the payment instrument. FI computing system 130 may also perform operations that access the RFP message maintained within RFP message queue 135, and delete the RFP message from RFP message queue 135 (e.g., in step 570 of FIG. 5C).

FI computing system 130 may also perform operations that obtain, from the elements of response data, one of the incentive confirmation indicative of the approval, or alternatively, the rejection, of a corresponding one of the targeted offers or incentives by user 101 (e.g., in step 572 of FIG. 5C), and that process the obtained incentive confirmation and determine whether user 101 approved, or rejected, the corresponding one of the targeted offers or incentives (e.g., in step 574 of FIG. 5C). If FI computing system 130 were to determine that user 101 accepted the corresponding one of the targeted offers or incentives (e.g., step 574; YES), FI computing system 130 may perform any of the exemplary processes described to provision the corresponding one of the targeted offers or incentives to user 101 (e.g., in step 576 of FIG. 5C).

FI computing system 130 may also perform operations that parse the received response data and determine whether the response data includes additional incentive confirmation awaiting provisioning (e.g., in step 578 of FIG. 5C). If, for example, FI computing system were to determine that the response data includes additional incentive confirmation awaiting provisioning (e.g., step 578; YES), exemplary process 500 may pass back to step 572, FI computing system 130 may also perform operations that obtain, from the elements of response data, an additional one of the incentive confirmation indicative of the approval, or alternatively, the rejection, of an additional one of the targeted offers or incentives by user 101. Alternatively, if FI computing system were to determine that the response data includes no additional incentive confirmations (e.g., step 578; NO), exemplary process 560 may be complete in step 580.

Referring back to step 574, If FI computing system 130 were to determine that user 101 rejected the corresponding one of the targeted offers or incentives (e.g., step 574; NO), exemplary process 560 may pass to step 578, and FI computing system 130 may perform operations that parse the received response data and determine whether the response data includes additional incentive confirmation awaiting provisioning.

Further, and referring back to step 566, if FI computing system 130 were to determine that user 101 rejected the requested, real-time payment (e.g., step 566; NO), FI computing system 130 may perform any of the exemplary processes described herein to broadcast one or more additional ISO-20022-compliant RTP messages that confirm the rejection of the requested, real-time payment by user 101 (e.g., in step 582 of FIG. 5C). FI computing system 130 may also perform operations that access the RFP message maintained within RFP message queue 135, and delete the RFP message from RFP message queue 135 (e.g., in step 584 of FIG. 5C). Exemplary process 560 may be complete in step 580.

C. Exemplary computing architectures

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including merchant application 106, mobile banking application 108, decomposition engine 146, analytical engine 148, notification engine 150, RTP engine 152, application programming interfaces (APIs) 214, 302, and 360, RTP engine 216, remittance analysis engine 316, intent determination module 320, incentive determination module 324, extraction module 362, interface element generation module 364, and behavioral determination module 402, can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, such as user 101, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. An apparatus comprising:
a communications interface;
a memory storing instructions; and
at least one processor coupled to the communications interface and to the memory, the at least one processor being configured to execute the instructions to:
receive, via the communications interface, a message associated with an exchange of data involving a first counterparty and a second counterparty, the message comprising elements of message data disposed within corresponding message fields, and the message data characterizing a real-time payment requested from the second counterparty by the first counterparty;
generate intent data associated with the data exchange based on the elements of the message data, and based on the intent data, obtain digital content associated with the data exchange; and
transmit, via the communications interface, notification data that includes the digital content to a device operable by the second counterparty, the notification data causing an application program executed at the device to present a portion of the digital content within a digital interface.

2. The apparatus of claim 1, wherein the at least one processor is further configured to execute the instructions to:
obtain, from the memory, mapping data associated with the message fields of the received message;
perform operations that obtain the elements of the message data from corresponding ones of the message fields based on the mapping data; and
store the elements of the message data within the memory, the elements of the message data comprising a first identifier of the first counterparty, a second identifier of the second counterparty, and a parameter value characterizing the data exchange.

3. The apparatus of claim 2, wherein:
the received message comprises a request-for-payment message, the message fields of the request-for-payment message being structured in accordance with a standardized data-exchange protocol; and
elements of the mapping data identify corresponding ones of the elements of the message data and corresponding ones of the message fields.

4. The apparatus of claim 2, wherein the at least one processor is further configured to execute the instructions to obtain, based on the mapping data, remittance information associated with the data exchange from one or more of the message fields, the remittance information comprising a uniform resource locator associated with one or more elements of formatted data maintained by a computing system.

5. The apparatus of claim 4, wherein the at least one processor is further configured to execute the instructions to extract at least one of the first identifier, the second identifier, or an additional parameter value characterizing the data exchange from corresponding portions of the uniform resource locator.

6. The apparatus of claim 4, wherein the at least one processor is further configured to execute the instructions to, based on the uniform resource locator, perform operations that request and receive the one or more elements of the formatted data from the computing system via the communications interface.

7. The apparatus of claim 6, wherein the at least one processor is further configured to execute the instructions to process the one or more elements of formatted data, and obtain at least one of the first identifier, the second identifier, or an additional parameter value characterizing the data exchange from the processed elements of formatted data.

8. The apparatus of claim 6, wherein the at least one processor is further configured to execute the instructions to:
process the one or more elements of the formatted data, and obtain one or more elements of contextual data that characterize the data exchange based on the processed elements of formatted data; and
generate the intent data associated with the data exchange based on portions of the elements of the message data and the contextual data.

9. The apparatus of claim 1, wherein the at least one processor is further configured to generate the intent data based on an application of a trained machine learning or artificial intelligence process to the elements of the message data.

10. The apparatus of claim 1, wherein:
the obtained digital content is associated with at least one of a product or service available to the second counterparty; and
wherein the at least one processor is further configured to execute the instructions to:
receive, via the communications interface, a response to the notification data from the device;
based on the response, perform operations that provision the at least one product or service to the second counterparty; and
store data associated with the at least one provisioned product or service within the memory.

11. A computer-implemented method, comprising:
receiving, using at least one processor, a message associated with an exchange of data involving a first counterparty and a second counterparty, the message comprising elements of message data disposed within corresponding message fields, and the message data characterizing a real-time payment requested from the second counterparty by the first counterparty;
using the at least one processor, generating intent data associated with the data exchange based on the elements of the message data, and based on the intent data, obtaining digital content associated with the data exchange; and
transmitting, using the at least one processor, notification data that includes the digital content to a device operable by the second counterparty, the notification data causing an application program executed at the device to present a portion of the digital content within a digital interface.

12. The computer-implemented method of claim 11, further comprising:
obtaining, using the at least one processor, mapping data associated with the message fields of the received message;
performing operations, using the at least one processor, that obtain the elements of the message data from corresponding ones of the message fields based on the mapping data; and
storing, using the at least one processor, the elements of the message data within a data repository, the elements of the message data comprising a first identifier of the first counterparty, a second identifier of the second counterparty, and a parameter value characterizing the data exchange.

13. The computer-implemented method of claim 12, wherein:
the received message comprises a request-for-payment message, the message fields of the request-for-payment message being structured in accordance with a standardized data-exchange protocol; and
elements of the mapping data identify corresponding ones of the elements of the message data and corresponding ones of the message fields.

14. The computer-implemented method of claim 12, further comprising obtaining, using the at least one processor, remittance information associated with the data exchange from one or more of the message fields based on the mapping data, the remittance information comprising a uniform resource locator associated with one or more elements of formatted data maintained by a computing system.

15. The computer-implemented method of claim 14, further comprising performing operations, using the at least one processor, that extract at least one of the first identifier, the second identifier, or an additional parameter value characterizing the data exchange from corresponding portions of the uniform resource locator.

16. The computer-implemented method of claim 14, further comprising, based on the uniform resource locator, and using the at least one processor, performing operations that request and receive the one or more elements of the formatted data from the computing system.

17. The computer-implemented method of claim 16, wherein:
the computer-implemented method further comprises:
processing the one or more elements of the formatted data using the at least one processor;
obtaining, using the at least one processor, at least one of the first identifier, the second identifier, or an additional parameter value characterizing the data exchange from the processed elements of the formatted data; and
obtaining, using the at least one processor, one or more elements of contextual data that characterize the data exchange based on the processed elements of the formatted data; and
generating the intent data comprises generating the intent data associated with the data exchange based on portions of the elements of the message data and the contextual data.

18. The computer-implemented method of claim 11, wherein generating the intent data comprises generate the intent data based on an application of a trained machine learning or artificial intelligence process to the elements of the message data.

19. The computer-implemented method of claim 11, wherein:
the obtained digital content is associated with at least one of a product or service available to the second counterparty; and
the computer-implemented method further comprises:
receiving, using the at least one processor, a response to the notification data from the device;
based on the response, performing operations, using the at least one processor, that provision the at least one product or service to the second counterparty; and
storing, using the at least one processor, data associated with the at least one provisioned product or service within a data repository.

20. A tangible, non-transitory computer-readable medium storing instructions that, when executed by at least one processor, cause the at least one processor to perform a method, comprising:
receiving a message associated with an exchange of data involving a first counterparty and a second counterparty, the message comprising elements of message data disposed within corresponding message fields, and the message data characterizing a real-time payment requested from the second counterparty by the first counterparty;
generating intent data associated with the data exchange based on the elements of the message data, and based on the intent data, obtaining digital content associated with the data exchange;
transmitting notification data that includes the digital content to a device operable by the second counterparty, the notification data causing an application program executed at the device to present a portion of the digital content within a digital interface.
